(19) United States
(12) Patent Application Publication
(10) Pub. No.: US 2026/0005712 A1
(43) Pub. Date: Jan. 1, 2026

(54) METHODS AND APPARATUS FOR ESTIMATING DIGITAL PRE-DISTORTION COEFFICIENTS

(71) Applicant: Texas Instruments Incorporated, Dallas, TX (US)

(72) Inventors: Sai Harshita Aluwala, Bangalore (IN); Jawaharlal Tangudu, Bangalore (IN); Sashidharan Venkatraman, Bangalore (IN); Jaiganesh Balakrishnan, Bangalore (IN); Sarma Sundareswara Gunturi, Bangalore (IN); Pankaj Gupta, Bangalore (IN); Harishankar Ramesh, Bengaluru (IN); Varun Padavu Devaraj, Bangalore (IN)

(21) Appl. No.: 19/243,442

(22) Filed: Jun. 19, 2025

(30) Foreign Application Priority Data
Jun. 26, 2024 (IN) 202441048846

(51) Int. Cl. H04B 1/04

(52) U.S. Cl. CPC H04B 1/0475

(57) ABSTRACT

In an embodiment, a method includes: providing a first set of coefficients to a digital pre-distortion (DPD) corrector, the DPD corrector receiving a input signal having a first profile, the first set of coefficients being associated with the first profile; in response to detecting a change in a profile of the input signal from the first profile to a second profile, extracting, in response to an output signal converging to the input signal, a second set of coefficients corresponding to the second profile, the output signal being based on an output of the DPD corrector; and generating a third set of coefficients based on the first and second sets of coefficients, the third set being different from the first and second sets.

### CROSS-REFERENCE TO RELATED APPLICATION

This patent application claims the benefit of and priority to Indian Provisional Patent Application No. 202441048846 filed Jun. 26, 2024, which is hereby incorporated herein by reference in its entirety.

### TECHNICAL FIELD

The present disclosure relates generally to an electronic system and method, and, in particular embodiments, to methods and apparatus for estimating digital pre-distortion coefficients.

### BACKGROUND

Wireless communications technology enables a wide variety of electronic devices (e.g., mobile phones, tablets, laptops, etc.) to support the execution of increasingly diverse and complex workloads. The secure, efficient, and accurate exchange of information over a wireless medium includes technical challenges. One such technical challenge is attenuation, which refers to the continued dissipation of a signal as the signal traverses a medium. In general, a signal will have more attenuation when transmitted through a wireless medium than the signal would have when transmitted through a wired medium. To counteract signal attenuation, manufacturers include power amplifier (PA) circuitry in a device to boost the power of a signal before transmission through a medium.

### SUMMARY

In accordance to an embodiment, a method includes: providing a first set of coefficients to a digital pre-distortion (DPD) corrector, the DPD corrector receiving a input signal having a first profile, the first set of coefficients being associated with the first profile; in response to detecting a change in a profile of the input signal from the first profile to a second profile, extracting, in response to an output signal converging to the input signal, a second set of coefficients corresponding to the second profile, the output signal being based on an output of the DPD corrector; and generating a third set of coefficients based on the first and second sets of coefficients, the third set being different from the first and second sets.

In accordance to an embodiment, a method includes: detecting a profile change in an input signal; selecting, in response to the profile change, a first coefficient corresponding to a first profile type of the input signal to pre-distort the input signal during a first iteration of digital pre-distortion correction; and generating a regularization vector based on at least one converged coefficient corresponding to a second profile type different than the first profile type of the first coefficient; and estimating a second coefficient for pre-distorting the input signal during a second iteration based on the regularization vector.

In accordance to an embodiment, a method includes: determining a number of profile changes of an input signal during a period of time; comparing the number of profile changes to a threshold number; identifying two or more profile types of the input signal during the period of time; triggering a capture of samples of the input signal; and determining whether to update a coefficient used for pre-distorting the input signal or retain a previous coefficient used for pre-distorting the input signal based on whether the capture of samples includes samples of the two or more profile types.

In accordance to an embodiment, a device includes: a digital pre-distortion (DPD) corrector having an output and an input; a digital-to-analog converter (DAC) having an input coupled to the output of the DPD corrector, and an output; a filter having an input coupled to the output of the DAC, and an output; an amplifier having an input coupled to the output of the filter; a DPD estimator having a first input coupled to the output of the amplifier, a second input coupled to the input of the DPD corrector, and an output; and a multiplexer having a first input coupled to the output of the DPD estimator, and an output coupled to the DPD corrector.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A is an example illustration of example profiles of an input signal;

FIG. 1B is an example table including example profile changes between the example profiles of FIG. 1A;

FIG. 2 is a block diagram of transmitter circuitry including example DPD coefficient estimation circuitry;

FIG. 3 is a block diagram of the example DPD coefficient estimation circuitry of FIG. 2;

FIG. 4 is a block diagram of an example combined profile estimate (CPE) estimator;

FIG. 5 is a flowchart representative of at least one of example machine-readable instructions or example operations that may be at least one of executed, instantiated, or performed using an example programmable circuitry implementation of example CPE estimator of FIG. 3;

FIG. 6 is a block diagram of an example profile agnostic coefficient set (PACS) regularization generator;

FIG. 7 is a flowchart representative of at least one of example machine-readable instructions or example operations that may be at least one of executed, instantiated, or performed using an example programmable circuitry implementation of the example PACS regularization generator of FIG. 6;

FIG. 8 is a block diagram of an example DPD estimator of FIG. 3; and

FIG. 9 is a flowchart representative of at least one of example machine-readable instructions or example operations that may be at least one of executed, instantiated, or performed using an example programmable circuitry implementation of the DPD estimator of FIGS. 3 and 8.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Embodiments of the present disclosure are described in specific contexts, e.g., in a wireless transmitter, e.g., that is part of a transceiver in a wireless base station. Some embodiments may be used in other circuits or applications, such as wireless mobile devices or other personal electronics, and/or in wired communication protocols.

In an embodiment, digital pre-distortion (DPD) performance is improved under varying input signal conditions. The improvement of DPD performance may improve performance characteristics of a transmitter.

Generally, manufacturers may include PA circuitry in electronic devices (e.g., wireless base stations) to boost the power of signals before transmission through a medium. To improve the efficiency of PA circuitry (e.g., to increase a ratio of output power to input power), the PA circuitry may be operated in a non-linear region (e.g., a saturation region). As the temperature of or input signal profile to PA circuitry changes, the non-linearity of the PA circuitry can change. While an electronic device (e.g., a wireless base station) can save power and resources by operating PA circuitry at an improved efficiency, the PA circuitry can generate non-linear output signals as a result of being operated in a non-linear region.

For example, PA circuitry operated in a non-linear region may create harmonic distortion (HD) and inter-modulation (IMD) spectral components in an output signal. Such distortion can increase at least one of an adjacent channel leakage ratio (ACLR) or an error vector magnitude (EVM) in an output signal generated by PA circuitry. ACLR may be understood as a measure of (a) relative power in specified channels offset from an assigned channel of a transmitted signal with respect to (b) the power transmitted within the assigned channel. EVM is a measure of deviation of amplitudes and phase shifts of symbols in a transmitted signal from ideal constellation points. In examples described herein, an example frequency band may be divided into one or more channels where a channel refers to a frequency range within the frequency band. Accordingly, ACLR may be used as a measure of signal leakage outside an assigned frequency range and EVM may be used as a measure of in-range signal quality loss. Therefore, an increase in EVM results in a lower probability of a receiver properly decoding a received signal.

In some examples, manufacturers utilize DPD correction to compensate for nonlinearity of PA circuitry. For example, DPD correction may be utilized in every instance of transmitter circuitry of a wireless base station. Digital circuitry implementing DPD correction can be integrated with a base-band processor or a transceiver system on a chip (SoC).

DPD correction may include distorting an input baseband signal before the input baseband signal is sent to the PA circuitry. For example, a nonlinear output caused by PA circuitry can be characterized as a function f(x), where x is the input signal to the PA circuitry and f( ) is a distortion function representative of the non-linearity of the PA circuitry. DPD correction may counteract nonlinearities by applying an inverse function, f⁻¹( ), to the input signal and providing the output to the PA circuitry. In some examples, the inverse function f⁻¹( ) is referred to as a pre-distortion. As such, the non-linearity introduced by PA circuitry is counteracted by the pre-distortion applied to the input signal and the PA circuitry generates an amplified version of the input signal (e.g., f(f⁻¹(x))=x). Thus, DPD correction reduces nonlinearity of PA circuitry while allowing the PA circuitry to operate at an improved efficiency.

Manufacturers may use a wide variety of DPD models to define an inverse function f⁻¹( ). One such model is a generalized memory polynomial model. The generalized memory polynomial model is illustrated below in Equation 1.

$${x}_{DPD} ( n ) = {\sum }_{i = 1}^{{N}_{c}} {c}_{i} * x ( n - {l}_{1 , i} ) * {g}_{i} ( \vert x ( n - {l}_{2 , i} ) \vert ) \qquad Equation 1$$

In the example of Equation 1, x(n) represents an input signal, x_{DPD}(n) represents a pre-distorted version of the input signal, |x(n)| represents a function to compute the envelope of x(n), and c represents a coefficient used minimize an error between x(n) and the output of the PA 210 (e.g., y(n)). In Equation 1, gᵢ( ) represents a non-linear function of an envelope of the input signal x(n) for each ith term. For example, for a given x(n), N_{c} non-linear terms are computed, where i is the iterating/indexing variable that goes from 1 to N_{c}, where N_{c} is the total number of terms in the summation (denoted by

$${\sum }_{i = 1}^{{N}_{c}} ( \cdot ) ) .$$

In Equation 1, l_{1,i} and l_{2,i} represent delays (e.g., at least one of positive or negative) applied to x(n) and |x(n)|, respectively. For each input x(n), non-linear terms are determined and stored as a matrix H_{N×Nc}, where N corresponds to a number of input samples used for generation (e.g., estimation) of x_{DPD}(n) and N_{c} corresponds to a number of coefficients c used to estimate x_{DPD}(n).

In some examples, coefficients for the generalized memory polynomial model of Equation 1 are determined iteratively based on a non-linear optimization problem. A solution to the non-linear optimization problem is illustrated below in Equation 2.

$${c}_{t} = {c}_{t - 1} + {( {H}^{H} H )}^{- 1} {H}^{H} e \qquad Equation 2$$

Equation 2 represents an update rule for cₜ, where cₜ is a column vector c of length N_{c}×1 with each element being the scalar cᵢ at a current iteration or time step t that is being optimized by the update rule to improve the model fit of Equation 1. “Model-fit” refers to how closely the model output represents an ideal output. The general terminology is that Equation 1 represents the DPD model where cᵢ can be anything. For this model, DPD estimation chooses cᵢ such that DPD “fits the inverse-PA-model” well.

In Equation 2, cₜ₋₁ represents the column vector c at the previous iteration or time step t−1. For example, the update rule calculates the new cₜ based on the previous cₜ₋₁. In Equation 2, H represents a Jacobian matrix which describes how the model's output error changes as the parameter vector c changes. For example, in the Jacobian matrix H, each row of H corresponds to a different input sample in x(n) and each column of H corresponds to a different parameter in the column vector c. In Equation 2, H^{H} represents the conjugate transpose (e.g., Hermitian transpose) of the matrix H, and e represents the error vector describing the differences between the desired output of the system (e.g., output of the PA circuitry) and the actual output of the system that the model of Equation 1 produces with the current parameters in parameter vector cₜ₋₁. The update rule uses information in H to move the column vectors c in a direction that is expected to reduce the error e. In Equation 2, e is an error vector representing an error observed between the input signal and the output signal of the system, wherein the error is impacted by cₜ₋₁, the parameter vector c at the previous iteration or time step t−1. For example, e decreases as cₜ₋₁ optimizes the pre-distortion of the input signal and increases when cₜ₋₁ does not optimize the pre-distortion of the input signal.

In some examples, DPD estimation circuitry uses Equation 2 iteratively. For example, DPD estimation circuitry generates an initial guess for c, and then applies the update rule repeatedly until the parameters in the parameter vector c converge. The parameters in the parameter vector c converge when the changes in c become small or when the output of the PA circuitry matches the input of the digital pre-distortion model. As used herein, the update rule is referred to as “DPD estimation,” “coefficient estimation,” “DPD coefficient estimation,” or “estimation equation.” In some examples, DPD estimation takes 3 to 5 iterations until the parameters converge.

There are a variety of types of PA circuitry and a variety of use cases for PA circuitry. For example, PA circuitry can be manufactured using a variety of process nodes (e.g., a Gallium Nitride (GaN) based process node, a laterally-diffused metal-oxide semiconductor (LDMOS) based process node, etc.) and with a variety of architectures (e.g., a Doherty architecture, a class AB architecture, etc.). Also, PA circuitry can be operated at a variety of power levels depending on use case and across a variety of signal bandwidths (e.g., profiles). For example, power levels include <5 Watts (W) in small cell applications, 5-10 W in massive multiple-input multiple-output (MIMO) applications, >10 W in macro base station applications, etc., and signal bandwidths include anywhere between 5 Megahertz (MHz) to 300 MHz.

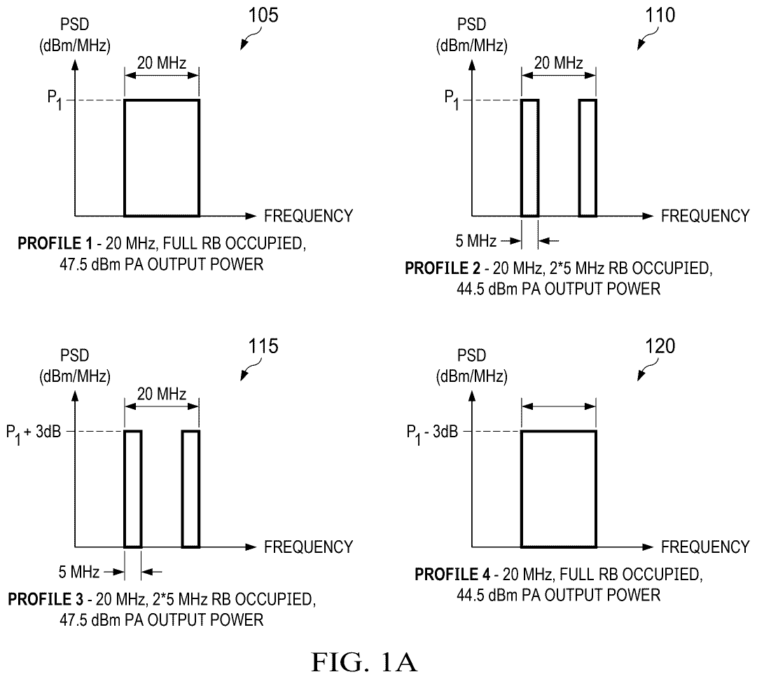

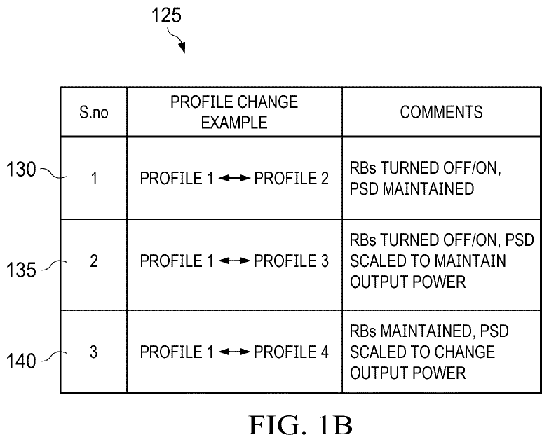

FIG. 1A illustrates examples of profiles of an input signal that affect how PA circuitry is operated, according to an embodiment of the present disclosure. FIG. 1A includes a first profile 105, a second profile 110, a third profile 115, and a fourth profile 120. Each of the profiles 105, 110, 115, and 120 represent a channel bandwidth of a base station serving one or more users in a specific type of application, along with a transmission bandwidth. Channel bandwidth refers to the total frequency range available for transmission (e.g., 20 MHz), while transmission bandwidth is a portion of that channel bandwidth used for actual data transmission. FIG. 1A illustrates that the transmission bandwidth can change based on the number of users the base station serves or the user conditions that the base station is serving (e.g., how much data is being transmitted at a time). In some examples, the user conditions of the base station can be determined based on how many resource blocks (RBs) are used for data transmission. In some examples, a resource block is the smallest unit of resources that can be allocated to a user and is represented as a grouping of frequency channels within the channel bandwidth. For example, each RB can occupy a specific amount of bandwidth (e.g., 180 kHz, 5 MHz, etc.). RBs are turned on and off based on how much data is to be transmitted. When more RBs are turned on, the transmission bandwidth increases, and when RBs are turned off, transmission bandwidth decreases. When all RBs are turned on, the transmission bandwidth is equal to the channel bandwidth because the full channel bandwidth is being used for data transmission.

In FIG. 1A, the channel bandwidth of the base station for each of the profiles 105-120 is 20 MHz and is represented in MHz on the x-axis. In FIG. 1A, the x-axis also represents the transmission bandwidth in megahertz (MHz). In FIG. 1A, the power spectral density (PSD) of the profile is represented as dBm/MHz on the y-axis. PSD represents the power of a signal's distribution across a frequency spectrum (e.g., the transmission bandwidth), measured in decibel-milliwatts per megahertz (dBm/MHz).

The first profile 105 illustrated in FIG. 1A corresponds to a 47.5 dBm transmitted signal over the 20 MHz transmission bandwidth. For example, the first profile 105 corresponds to a situation where all the RBs are turned on, causing a full occupation of the channel bandwidth and causing the PA circuitry to operate at a higher power (e.g., 47.5 dBm).

The second profile 110 illustrated in FIG. 1A corresponds to a 44.5 dBm transmitted signal over 10 MHz transmission bandwidth. For example, the second profile 110 corresponds to a situation where portions of the channel bandwidth being used to transmit data. For example, two 5 MHz RBs are occupied, resulting in 10 MHz transmission bandwidth. The power of the transmission signal of the second profile 110 is averaged over a smaller transmission bandwidth than the first profile 105 and, thus, has less power than the first profile 105.

The third profile 115 illustrated in FIG. 1A corresponds to a 47.5 dBm transmitted signal over a 10 MHz transmission bandwidth. The third profile 115 corresponds to the same situation as the second profile 110 (e.g., where two 5 MHz RBs are being occupied), but the power of the transmitted signal is scaled by positive 3 dB to maintain an output power of the PA circuitry. Therefore, the power of the third profile 115 is equal to the power of the first profile 105, but the transmission bandwidth is different.

The fourth profile 120 illustrated in FIG. 1A corresponds to a 44.5 dBm transmitted signal over a 20 MHz transmission bandwidth. The fourth profile 120 corresponds to the same situation at the first profile 105 (e.g., where all RBs are occupied), but the power of the transmitted signal is scaled by negative 3 dB to change the output power of the PA circuitry. Therefore, the power of the fourth profile 120 is less than the power of the first profile 105, but the transmission bandwidth is the same.

As described above, the profile of the input signal can change in its power and/or bandwidth depending on the user conditions that a base station is working for. For example, if there are a lower number of users, the base station may reduce its bandwidth and power. If there are a higher number of users, the base station might increase its bandwidth and power.

FIG. 1B illustrates an example table 125, according to an embodiment of the present disclosure. The example table 125 includes profile changes between the profiles 105-120 of FIG. 1A. The table 125 has a first profile change 130, a second profile change 135, and a third profile change 140.

The first profile change 130 illustrated in FIG. 1B corresponds to a change in the transmitted signal between the first profile 105 and the second profile 110. For example, the first profile change 130 describes why the transmitted signal changes between the first profile 105 and the second profile 110. In some examples, the transmitted signal changes from the first profile 105 to the second profile 110 when the base station turns off resource blocks (RBs) and the power spectral density (PSD) is not adjusted to accommodate for the reduction in transmission bandwidth. Alternatively, the transmitted signal changes from the second profile 110 to the first profile 105 when the base station turns on RBs and the PSD is not adjusted to accommodate for the increase in transmission bandwidth.

The second profile change 135 illustrated in FIG. 1B corresponds to a change in the transmitted signal between the first profile 105 and the third profile 115. For example, the second profile change 135 describes why the transmitted signal changes between the first profile 105 and the third profile 115. In some examples, the transmitted signal changes from the first profile 105 to the third profile 110 when the base station turns off resource blocks (RBs) and adjusts the power spectral density (PSD) to accommodate for the reduction in transmission bandwidth. Alternatively, the transmitted signal changes from the third profile 115 to the first profile 105 when the base station turns on RBs and adjusts the PSD to accommodate for the increase in transmission bandwidth.

The third profile change 140 illustrated in FIG. B corresponds to a change in the transmitted signal between the first profile 105 and the fourth profile 120. For example, the third profile change 140 describes why the transmitted signal changes between the first profile 105 and the fourth profile 120. In some examples, the transmitted signal changes from the first profile 105 to the fourth profile 120 when the base station adjusts only the power spectral density (PSD) to change the power of the signal. In the third profile change 140, the transmission bandwidth stays the same (e.g., the number of RBs being occupied is maintained).

Given the examples set forth in FIGS. 1A and 1B, the profile of the input signal may not be constant. Each type of PA circuitry and user condition includes different non-linearity. As such, estimated DPD coefficients for one profile is not accurate for a different profile. For example, a DPD estimate for a low power signal may not be accurate for a high power signal, and vice versa. Additionally, DPD coefficients may not be accurate for some changes in the temperature of PA circuitry. For example, if the temperature of the PA circuitry increases by five degrees, the non-linearity of the PA circuitry changes and, thus, the DPD coefficient has to change. Additionally, DPD coefficients may not be accurate after a period of time. For example, a DPD coefficient used to improve or optimize the non-linear function of the PA circuitry on a first day may not accurately optimize the non-linear function on a second day.

Due to the changes in non-linearity of the PA circuitry, there are many DPD coefficients to model its non-linearity. In some examples, the non-linear functions of the model are implemented as a collection of lookup tables (LUTs), whose contents are derived from the model and the estimated model coefficients.

In some examples, DPD coefficient estimation circuitry has improved coefficient estimation for changes in time between coefficient estimation and for changes in temperature of the PA circuitry. For example, temperature changes of the PA circuitry are of the order of minutes, hours, or days. DPD coefficients are estimated periodically using on-air transmit signals. As used herein, “on-air” is when the transmitter is actively transmitting data over airwaves. The on-air estimation of DPD coefficients for the transmit signal may be in the order of seconds. Therefore, DPD coefficients may be effective for time and temperature changes.

However, DPD coefficient estimation circuitry may not track PA behavior changes due to abrupt changes in the profile of the input signal. For example, profile changes, such as profile changes 130-140 of FIG. 1B may occur abruptly. In one instance, a base station may serve 10 users, and the next instance the base station may serve 100 users, causing a change in the profile of the transmitted signal. Because the DPD coefficients estimated on one signal profile may not be accurate for a different signal profile, when the input changes suddenly, there may be performance degradation on the newer signal. The performance degradation may occur due to the correction from the previous input signal profile being applied to the new signal profile for a short amount of time before adapting.

In some examples, DPD coefficient estimation circuitry resets the DPD coefficients when the profile of an input signal changes, e.g., to reduce performance degradation of the input signal at the output of the PA circuitry. However, performance still may degrade (e.g., significantly) until the coefficients re-converge for the new signal profile because the DPD estimation circuitry may take, e.g., 3 to 5 iterations of coefficient estimation until convergence.

In some examples, DPD estimation circuitry stores DPD correction sets as lookup tables (LUTs) for each profile of an input signal. In some such examples, when the signal profile changes, the DPD estimation circuitry detects the type of profile and switches to the corresponding coefficient and reconverges from that coefficient. While the performance of DPD estimation improves when using LUTs, coefficient correction sets may need to be stored for a sufficient number of profiles. In some examples, memory needed for one DPD coefficient correction set may be equivalent to a high number of bytes. For example, 18 KB of memory may be needed where a resolution of an LUT (e.g., number of entries in an LUT) is equal to 128, a number of LUTs equals 36, and a number of bytes used per entry is equal to 4 B (e.g., 128×36×4=18 KB). Thus, there may be a large memory overhead for DPD estimation circuitry that stores DPD correction sets for each profile.

In some examples, the DPD estimation circuitry does not generate coefficients that converge for any profile when the profile of the input signal changes frequently relative to convergence time.

Some embodiments implement a DPD coefficient estimation system that reduces performance degradation caused by profile changes in the input signal.

Some embodiments generate a single profile agnostic coefficient set that includes coefficients that work well across all profiles of an input signal. For example, the profile agnostic coefficient set provides a reasonable coefficient starting point for estimation that does not increase at least one of an adjacent channel leakage ratio (ACLR) or an error vector magnitude (EVM) in an output signal generated by PA circuitry.

Some embodiments determine when to retain the DPD coefficients and collect more profile data from the input signal or when to update DPD coefficients and continue DPD iteration based on how frequently the profile of the input signal changes. By determining when to retain or when to update DPD coefficients, the DPD coefficient estimation system may advantageously enable convergence of DPD coefficients such that all profiles have a satisfactory performance when the profile of the input signal changes faster than DPD coefficients converge. Therefore, some embodiments provide improved performance of DPD estimation in two situations: (1) where the profile of the input signal changes slower than DPD coefficients converge and (2) where the profile of the input signal changes faster than the DPD coefficients converge.

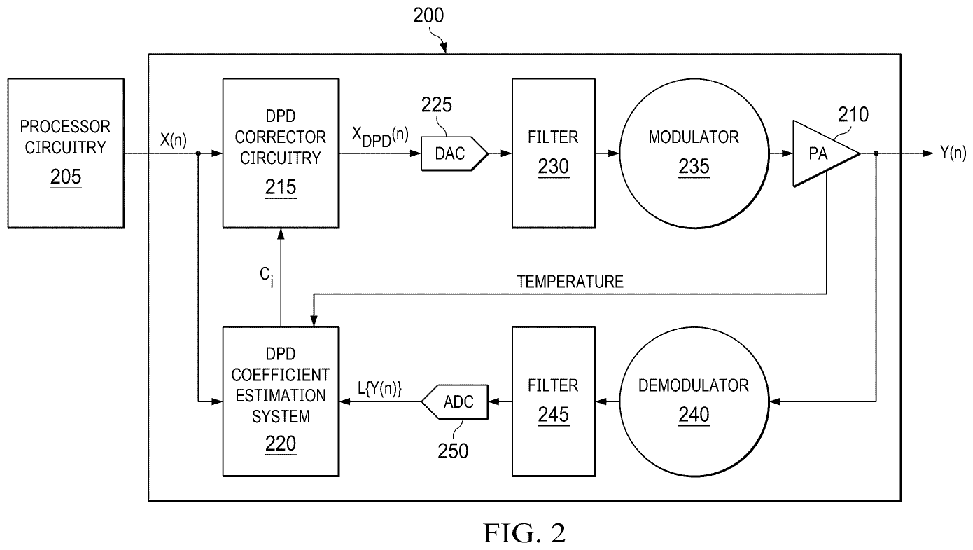

FIG. 2 is an example block diagram of transmitter circuitry 200 according to an embodiment of the present disclosure. The transmitter circuitry 200 is coupled to processor circuitry 205 and includes power amplifier (PA) circuitry 210, digital pre-distortion (DPD) corrector circuitry 215, DPD coefficient estimation system 220, a digital to analog converter (DAC) 225, a first filter 230, a modulator 235, a demodulator 240, a second filter 245, and an analog to digital converter (ADC) 250. The transmitter circuitry 200 is to perform transmission in a channel of a frequency band.

The transmitter circuitry 200 may be implemented by digital circuitry and/or analog circuitry.

In the illustrated example of FIG. 2, the processor circuitry 205 may be implemented by a generic or customer processor or controller coupled to a memory and configured to execute instructions in such memory. In some embodiments, processor circuitry 205 may include hardware accelerators. In some embodiments, processor circuitry 205 includes a state machine. In some embodiments, processor circuitry 205 may be implemented by a central processor unit (CPU), a graphics processor unit (GPU), a digital signal processor (DSP), or custom hardware (e.g., implemented by an Application Specific Integrated Circuit (ASIC) or a Field Programmable Gate Array (FPGA)), among others. In some embodiments, processor circuitry 205 may be implemented in hardware without executing instructions from a memory. Other implementations may also be possible.

In some embodiments, the processor circuitry 205 generates one or more digital signals (x(n)) to be transmitted to users via the transmitter circuitry 200. In the example of FIG. 2, the transmitter circuitry 200 converts the digital signal (e.g., a base-band signal in the channel) to a radio frequency (RF) band signal (y(n)) to be transmitted (e.g., by an antenna, not shown). In some embodiments, the transmitter circuitry 200 applies DPD correction to the digital signal (x_{DPD}(n)) to counteract non-linearity of PA circuitry 210 included in the transmitter circuitry 200.

In the illustrated example of FIG. 2, the DPD corrector circuitry 215 receives the digital signal (x(n)) to be transmitted by the PA circuitry 210. The DPD corrector circuitry 215 receives DPD coefficients (cᵢ) that optimize a non-linear model implemented by the DPD corrector circuitry 215, the non-linear model used to pre-distort the digital input signal (x(n)) and generate a pre-distorted input signal (x_{DPD}(n)). For example, in some embodiments, the DPD corrector circuitry 215 is configured to generate a pre-distorted digital signal x_{DPD}(n) as described in Equation 1 above. The DPD corrector circuitry 215 provide the pre-distorted digital signal x_{DPD}(n) to the DAC 225. In some examples, the DPD corrector circuitry 215 includes interpolator circuitry to oversample the digital signal x(n) to avoid the effects of aliasing that may result from bandwidth expansion during pre-distortion of the digital signal x(n). For example, if the input signal x(n) is sampled at about 250 MSPS (e.g., the input signal has a bandwidth of 200 MHz), then the interpolator circuitry may oversample the input signal to about 750 MSPS (e.g., with an interpolation factor of 3).

In the illustrated example of FIG. 2, the DAC 225 converts the pre-distorted input signal x_{DPD}(n) to an analog signal. For example, in some embodiments, the DAC 225 is configured to generate a signal representative of the pre-distorted input signal (x_{DPD}(n)).

In the illustrated example of FIG. 2, the first filter 230 removes any unwanted signals from the analog conversion of the pre-distorted input signal (x_{DPD}(n)) before modulation. For example, in some embodiments, the first filter 230 filters out high frequency components and quantization noise in the signal generated by the DAC 225.

In the illustrated example of FIG. 2, the modulator 235 modulates the output signal of the DAC 225 with a frequency to generate an RF signal to enable the PA circuitry 210 to wirelessly transmit the analog signal. For example, the modulator 235 up converts the signal to (1) generate an RF signal that has a frequency that can be transmitted over an antenna, cable, or any communication channel, and (2) adapt the transmit signal such that it uses a specific frequency band of the channel. In some examples, the modulator 235 is configured with a specific modulating signal (e.g., carrier frequency signal) that achieves the modulation goals.

In the illustrated example of FIG. 2, the PA circuitry 210 receives the up converted RF signal from the modulator 235 and amplifies the RF signal to generate a transmission signal y(n) that can be transmitted over an antenna, cable, or any communication channel. In some examples, the PA circuitry 210 introduces non-linearities into the RF signal, causing the RF signal to distort.

In some embodiments, the transmitter circuitry 200 includes an observation path or a feedback path to observe the output of the PA circuitry 210 (e.g., the transmission signal y(n)) and harmonize the transmission signal y(n) with the digital input signal x(n). The feedback path includes the demodulator 240 coupled to the output of the PA circuitry 210, the second filter 245 coupled to the output of the demodulator 240, the ADC 250 coupled to the output of the second filter 245, and the DPD coefficient estimation system 220 coupled to the output of ADC 250 and coupled to an input of the DPD corrector circuitry 215.

In the illustrated example of FIG. 2, feedback data (e.g., transmission signal y(n)) is fed into a DPD processing loop in a negative feedback fashion to pre-distort the digital input signal x(n) and counteract distortion introduced by the PA circuitry 210. The DPD corrector circuitry 215 may pre-distort the digital input signal x(n) in a manner consistent with the non-linearities of the PA circuitry 210. Therefore, the transmission signal y(n) is to be the analog equivalent of the digital input signal x(n).

The feedback path in the illustrated example of FIG. 2 includes the demodulator 240 to demodulate the transmission signal y(n). For example, the demodulator 240 down converts the RF signal (e.g., the transmission signal y(n)) to obtain the baseband signal. In some examples, the demodulator 240 removes the carrier frequency (e.g., RF frequency) injected into the baseband signal by the modulator 235.

The feedback path in the illustrated example of FIG. 2 includes the second filter 245 to remove unwanted frequencies from the RF signal introduced during the demodulation process. For example, the demodulator 240, which is configured to extract the original signal from a modulated carrier wave (e.g., the modulated RF signal), also generates unwanted high-frequency components (e.g., like the carrier wave and its harmonics) that need to be removed. The second filter 245 removes those and sends the original RF signal to the ADC 250.

The feedback path in the illustrated example of FIG. 2 includes the ADC 250 to convert the baseband signal into a digital signal L{y(n)} representative of the transmission signal y(n) that can be fed to the DPD coefficient estimation system 220. For example, in order for the DPD coefficient estimation system 220 to identify an error between the transmission signal y(n) and the digital input signal x(n), the ADC 250 has to convert the transmission signal to a digital signal.

The feedback path in the illustrated example of FIG. 2 includes the DPD coefficient estimation system 220 to estimate coefficients cᵢ that can be used by the DPD corrector circuitry 215 to account for changes in the profile of the input signal, changes in time, and changes in temperature of the PA 210 when modeling the non-linearity of the PA circuitry 210. As described above, as the signal profile to the PA circuitry 210 changes, the non-linearity of the PA circuitry 210 can change. As such, the DPD coefficient estimation circuitry 220 monitors the feedback digital signal L{y(n)} and adjusts at least one value of a non-linear function stored in the DPD corrector circuitry 215 to track changes in the non-linearity of the PA circuitry 210. For example, in some embodiments, the DPD coefficient estimation system 220 evaluates a signal generated by the PA circuitry 210 as compared to the digital input signal x(n). Based on the comparison, the DPD coefficient estimation system 220 estimates at least one updated value (e.g., a coefficient cᵢ) of a non-linear function stored in the DPD corrector circuitry 215.

In the illustrated example of FIG. 2, the DPD corrector circuitry 215 and the DPD coefficient estimation system 220 may be implemented by programmable circuitry. The processor circuitry 205 may program the DPD corrector circuitry 215 and the DPD coefficient estimation system 220 at startup of the transmitter circuitry 200 to compensate for non-linearity of the PA circuitry 210. In some examples, the processor circuitry 205 programs delay circuitry of the DPD coefficient estimation system 220 at startup of the transmitter circuitry 200. For example, because the DPD coefficient estimation system 220 measures the error between the L{Y(n)} and the digital input signal x(n), the DPD coefficient estimation system 220 implements proper delay blocks to ensure that the input from L{y(n)} and x(n) are compared correctly at the right timing.

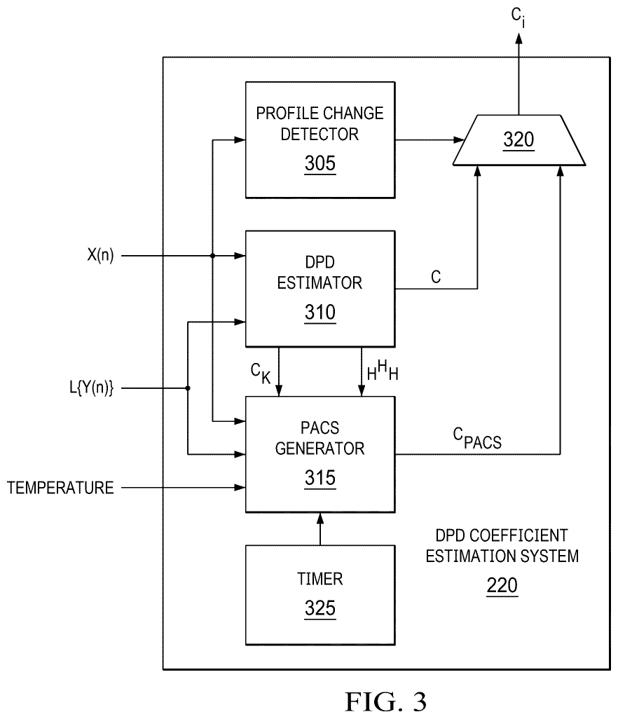

FIG. 3 is a block diagram of a possible implementation of DPD coefficient estimation circuitry 220 of FIG. 2, according to an embodiment of the present disclosure. In the example of FIG. 3, the DPD coefficient estimation circuitry 220 includes a profile change detector 305, a DPD estimator 310, a profile agnostic coefficient set (PACS) generator 315, a coefficient selector 320, and a timer 325.

In the illustrated example of FIG. 3, the profile change detector 305 receives the digital input signal x(n) and detects changes in the profile of the input signal x(n). In some examples, the profile change detector 305 uses a frequency analysis algorithm, such as the Fast Fourier Transform (FFT), to measure the power spectral density (PSD) of the input signal x(n). In some examples, the profile change detector 305 uses a different or the same frequency analysis algorithm to measure the transmission bandwidth of the input signal x(n). In some examples, the profile change detector 305 compares bandwidth and power statistics of the input signal x(n) over a current time window (e.g., 16 microseconds time window) against bandwidth and power statistics of the input signal x(n) during the time the output (cᵢ) of the DPD coefficient estimation system 220 was last updated.

In some examples, the profile change detector 305 generates value to send to the selection input. The value indicates when the comparison between the previous statistics and current statistics of samples of the input signal x(n) yields a difference. For example, when the bandwidth, power, etc., changes between the previous and current time windows, the profile change detector 305 may output a first value (e.g., a logic 1), and when the bandwidth and power does not change between the two samples, the profile change detector 305 may output a second value (e.g., a logic 0). In some examples, the profile change detector 305 compares types of statistics corresponding to the input signal x(n) different than the bandwidth and power.

In some embodiments, the profile change detector 305 may provide the first value or the second value (e.g., logic 0 or 1) to the output to instruct the coefficient selector 320 on which input to send to the DPD corrector circuitry 215. In some examples, a logic 0 selects the input from the DPD estimator 310 and a logic 1 selects the input from the PACS generator 315. The profile change detector 305 outputs a logic 0 to the coefficient selector 320 when the comparison between the profile of the input signal x(n) over a current time window (e.g., 16 microseconds time window) and the profile of the input signal x(n) during the time the output (cᵢ) of the DPD coefficient estimation system 220 was last updated x(n−1) does not yield a difference. The profile change detector 305 outputs a logic 1 to the coefficient selector 320 when the comparison between the profile of the input signal x(n) over a current time window (e.g., 16 microseconds time window) and the profile of the input signal x(n) during the time the output (cᵢ) of the DPD coefficient estimation system 220 was last updated x(n−1) yields a difference. In such examples, when the profile of the input signal x(n) does not change, the coefficient selector 320 sends the DPD coefficient c, generated by the DPD estimator 310, to the DPD corrector circuitry 215. When the profile of the input signal x(n) changes, the coefficient selector 320 sends the DPD coefficient generated by the PACS generator 315 to the DPD corrector circuitry 215. The DPD corrector circuitry 215 uses the DPD coefficient cᵢ to improve the inverse function (e.g., generalized memory polynomial model of Equation 1) by minimizing an error between x(n) and y(n) (e.g., L{y(n)}).

In some examples, the profile change detector 305 momentarily outputs the first value (e.g., logic 1). For example, when the comparison between the profile of the current input signal x(n) and the profile of the previous input signal x(n−1) yields a difference, the profile change detector 305 outputs the first value to the coefficient selector 320 for a first iteration of DPD estimation, and then outputs the second value to the coefficient selector 320 for the next iterations of DPD estimation.

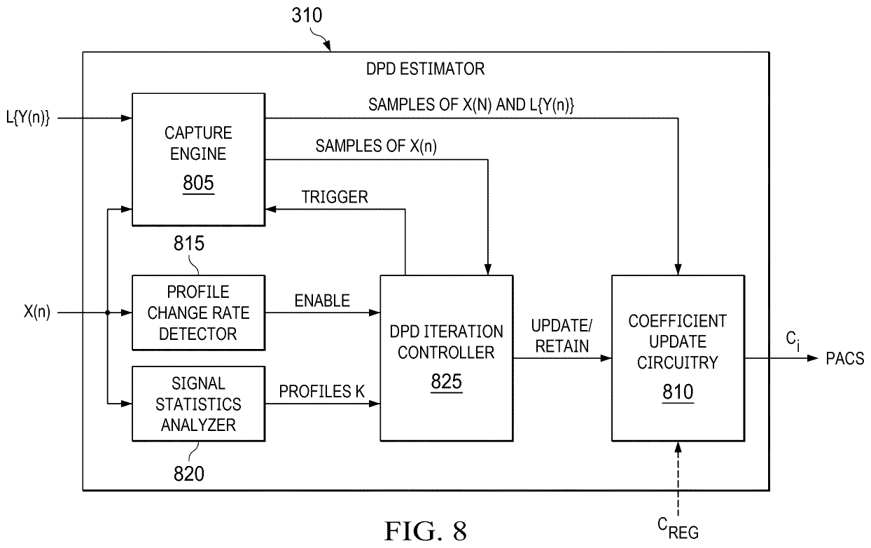

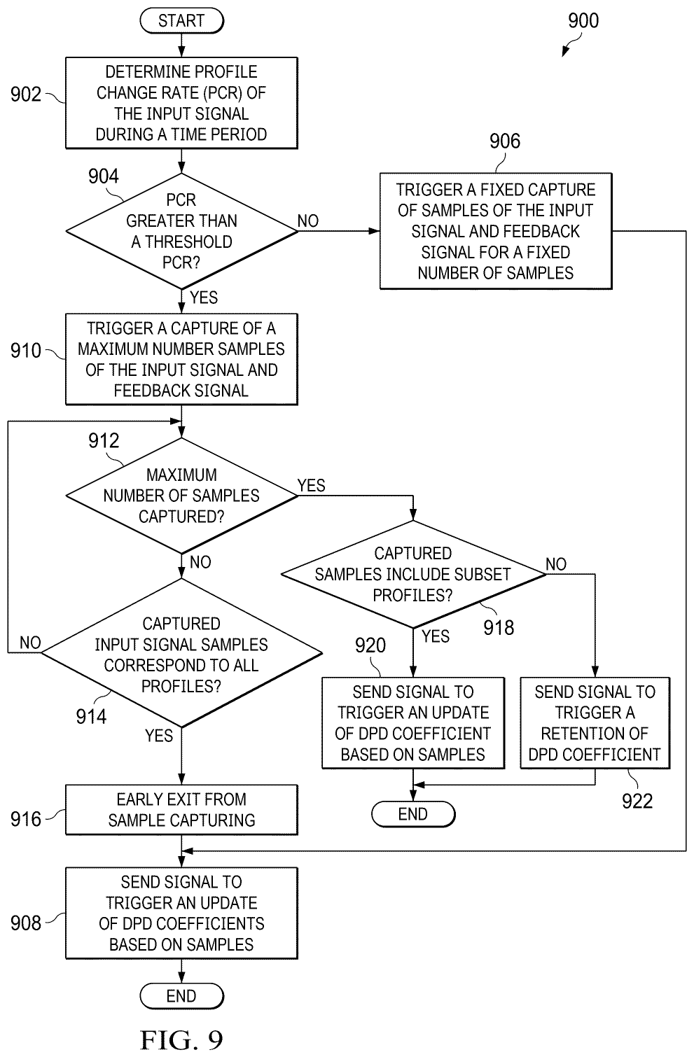

In the illustrated example of FIG. 3, the DPD estimator 310 may estimate coefficients cᵢ based on the update rule of Equation 2 described above. To estimate the coefficient cᵢ, the DPD estimator 310 receives the digital input signal x(n) and the output of the ADC 250. For example, the DPD estimator 310 captures samples of the input signal x(n) and samples of the feedback signal L{y(n)} and updates and generates the coefficient vector (c) based on the samples. An example implementation of the DPD estimator 310 is further illustrated and described, e.g., in FIGS. 8 and 9.

In the illustrated example of FIG. 3, the PACS generator 315 generates a profile agnostic coefficient set (PACS) for a set of observed profiles. As described above, the profile agnostic coefficient set provides a reasonable coefficient starting point for DPD estimation that does not increase at least one of an adjacent channel leakage ratio (ACLR) or an error vector magnitude (EVM) in the output signal y(n) generated by PA 210. In some examples, PACS is referred to as a combined profile estimate (CPE) coefficient (C_{CPE}). The CPE coefficient C_{CPE} is a coefficient vector generated by combining coefficients obtained for each of the signal profiles observed by the DPD estimator 310. Additionally, PACS may be obtained using a regularization technique for DPD coefficient estimation. In such an example, a regularization vector is determined by a combination of converged coefficient sets for different profiles. When the input profile corresponds to a particular chosen profile (e.g., a high power profile), the converged output of the DPD coefficient estimation system 220 is tapped off as PACS. For example, the PACS is selected for a first iteration in DPD estimation, and the next iterations of DPD estimation are based on a coefficient vector that has been regularized to all signal profiles except the signal profile that was selected as PACS. For example, when PACS is a coefficient corresponding to a high power signal profile, the next coefficients used for DPD estimation are regularized to lower power signal profiles. Alternatively, when PACS is a coefficient corresponding to a low power signal profile, the next coefficient used for DPD estimation are regularized to higher power signal profiles.

In some embodiments, the PACS generator 315 extracts converged coefficients (C_{K}) and corresponding correlation matrices from the DPD estimator 310 across different input profile to generate PACS. In some examples, a converged coefficient C_{K} is a coefficient vector that was used by the DPD corrector circuitry 215 to cause a convergence between the input signal x(n) and the output signal y(n). For example, the converged coefficient C_{K} may be the coefficient generated by the DPD estimator 310 on the 5^{th} iteration of DPD estimation. In some examples, each profile has a different converged coefficient C_{K}. While each profile has a different converged coefficient C_{K}, each converged coefficient C_{K} corresponds to a correlation matrix (H^{H}H_{K}) that describes how the output error of generalized memory polynomial model (e.g., Equation 1) changes as the DPD coefficient cᵢ changes.

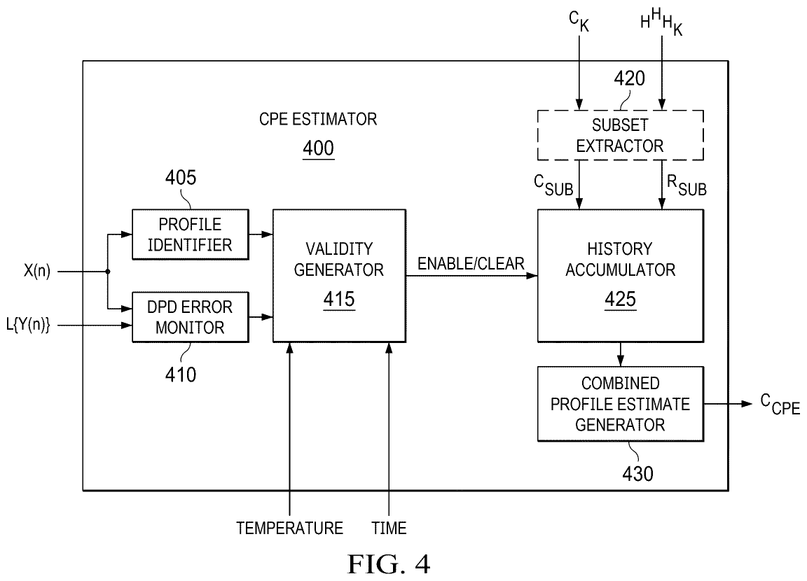

In some examples, the PACS generator 315 generates the C_{CPE} by accumulating a projected coefficient vector, corresponding to the converged coefficients C_{K}, with the corresponding non-linear term correlation matrix H^{H}H as new profiles are identified and extracted. In such an example, the DPD correction set LUT generated from C_{CPE} is a single table representing a coefficient vector cᵢ that is smaller in memory size than DPD correction sets stored as lookup tables (LUTs) for each profile of an input signal x(n). For example, the DPD correction set LUT generated from C_{CPE} uses X kB of memory whereas a minimum of four DPD correction sets uses Y kB of memory, where X is less than Y. In some examples, the C_{CPE} reduces the memory requirement of the DPD coefficient estimation system 220 by approximately 50% and, thus, reduces the memory requirement of the transmitter circuitry 200. Alternatively, when PACS is obtained by a regularization based converged coefficient C_{K} corresponding to one profile type, PACS reduces the memory requirement of the transmitter circuitry 200. An example implementation of the PACS generator 315 is further illustrated and described, e.g., in FIGS. 4, 5, 6, and 7.

In the illustrated example of FIG. 3, the DPD coefficient estimation system 220 includes the timer 325 to reset the PACS when a threshold amount of time is exceeded. For example, as described above, DPD coefficients are not accurate with time changes and temperature changes. For example, a DPD coefficient c₁ used for the first profile 105 (FIG. 1) may accurately optimize the generalized memory polynomial model used by the DPD corrector circuitry 215, e.g., on day 1, but may not accurately optimize the generalized memory polynomial model, e.g., 36 hours later (on day 3). Similarly, a PACS used, e.g., on day 1 may not be a great starting point for switching profiles, e.g., on day 3. As such, the timer 325 provides a threshold length of time when PACS starts to degrade, and the PACS generator 315 is to clear or reset C_{PACS} after the timer 325 exceeds or satisfies the threshold length of time.

Similarly, in the illustrated example of FIG. 3, the PACS generator 315 is to obtain a temperature signal from the PA 210 that indicates another instance of when the PACS generator 315 is to reset or clear the PACS. For example, a DPD coefficient c₁ used for the first profile 105 (FIG. 1) may accurately optimize the generalized memory polynomial model used by the DPD corrector circuitry 215 at a first temperature of the PA 210, but if that temperature drifts by a threshold amount of degrees, the DPD coefficient c₁ may degrade the output signal y(n). Similarly, a PACS used for a first temperature of the PA 210 may not be accurate for a second temperature.

In the illustrated example of FIG. 3, the coefficient selector 320 is a multiplexer that is to connect a selected coefficient set to the input of the DPD corrector circuitry 215. For example, the coefficient selector 320 is to select, based on an output of the profile change detector 305, the coefficient c from the DPD estimator 310 or the coefficient C_{PACS} from the PACS generator 315. In some examples, the coefficient selector 320 is implemented by processor circuitry.

FIG. 4 is a block diagram of an example combined profile estimate (CPE) estimator 400, according to an embodiment of the present disclosure. The CPE estimator 400 is an example implementation of the PACS generator 315 of FIG. 3. In the example of FIG. 4, the CPE estimator 400 includes a profile identifier 405, a digital pre-distortion error monitor 410, a validity generator 415, a subset extractor 420, a history accumulator 425, and a combined profile estimate generator 430.

In the illustrated example of FIG. 4, the profile identifier 405 is to identify a profile of the input signal x(n). For example, the profile identifier 405 receives samples of the input signal x(n) and uses frequency analysis algorithms to determine the profile. In some examples, the profile identifier 405 uses the frequency analysis algorithms to identify the power spectral density (PSD) of the input signal x(n) and to determine the transmission bandwidth. In some examples, the profile identifier 405 looks at input signal power statistics to identify a particular profile. Based on these features of the input signal x(n), the profile identifier 405 may determine a profile number or some type of grouping corresponding to the PSD, transmission bandwidth, and/or power statistics. For example, if the PSD corresponds to a power of 47.5 dBm transmitted over bandwidth of 20 MHz, the profile identifier 405 determines the input signal x(n) is in the first profile 105 (FIG. 1A), if the PSD corresponds to a power of 44.5 dBm transmitted signal over 10 MHz transmission bandwidth, the profile identifier 405 determines the input signal x(n) is in the second profile 110 (FIG. 1A), etc. In some examples, the power of the input signal x(n) can also be used to distinguish the first profile 105 and the second profile 110. The profile identifier 405 may use alternative statistics to identify the profile of the input signal x(n). In some examples, the profile identifier 405 notifies the validity generator 415 of the profile type of the input signal x(n). In some examples, the validity generator 415 uses the profile type to determine whether a combined profile estimate coefficient C_{CPE} is to be updated.

In the illustrated example of FIG. 4, the DPD error monitor 410 is to compare the input signal x(n) to the feedback signal L{Y(n)} to determine when convergence occurs. The DPD error monitor 410 determines whether a threshold amount of error exists between the input signal x(n) to the feedback signal L{Y(n)}. The error threshold is a value indicative of a small enough difference between the two signals to satisfy convergence.

In the illustrated example of FIG. 4, the validity generator 415 is to perform a series of validation checks to enable the history accumulator 425 to generate a C_{CPE}. The first check is to check whether a new profile has been identified by the profile identifier 405. For example, the validity generator 415 determines whether the profile has already been observed and processed by the history accumulator 425. For example, the validity generator 415 validates each profile identified by the profile identifier 405 and used to update the C_{CPE}. In some examples, the validity generator 415 validates the profiles by storing them in a dedicated memory, by generating a lookup table of profiles that have been observed and used to update the C_{CPE}, etc. The second check is for determining convergence between the input signal x(n) and the output signal y(n). The validity generator 415 determines when the output signal y(n) converges with the input signal x(n) based on an output of the DPD error monitor 410. For example, the DPD error monitor 410 notifies the validity generator 415 when the feedback signal L{y(n)} and, thus, the output signal y(n), converges with the input signal x(n).

In some examples, when the validity generator 415 determines that the profile type identified by the profile identifier 405 has not been observed, and subsequently receives a signal from the DPD error monitor 410 that convergence has occurred, the validity generator 415 generates an “enable” signal the enables the history accumulator 425. In some examples, enabling the history accumulator 425 refers to instructing the history accumulator 425 to accumulate projected coefficient vectors corresponding to converged coefficients with non-linear term correlation matrices.

In some examples, the validity generator 415 generates a “clear” signal that removes the C_{CPE} from memory. The validity generator 415 clears the C_{CPE} when a time since the C_{CPE} was generated exceeds a threshold amount of time or when temperature of the PA 210 (FIG. 2) drifts. The validity generator 415 receives a time signal from the timer 325 (FIG. 3) and a temperature signal from the PA 210. The validity generator 415 receives the time signal from the timer 325 when the timer 325 has completed a cycle, where the cycle begins when the C_{CPE} is generated (or updated) and ending when the threshold length of time has been met. The validity generator 415 periodically and frequently receives the temperature signal from the PA 210. For example, the validity generator 415 periodically compares the temperature of the PA 210 to the temperature of the PA 210 when the C_{CPE} was generated or updated. When the validity generator 415 determines that the temperature of the PA 210 has drifted a threshold amount from the temperature of the PA 210 when the C_{CPE} was generated or updated, the validity generator 415 generates the “clear” signal to remove the C_{CPE} from memory.

In the illustrated example of FIG. 4, the CPE estimator 400 includes the subset extractor 420 to extract portions or subsets of projected coefficient vectors, corresponding to converged coefficients C_{K}, and non-linear term correlation matrices H^{H}H_{K} from the DPD estimator 310. In some examples, the DPD estimator 310 provides the converged coefficient C_{K} and corresponding matrix H^{H}H_{K} in response to a request from the subset extractor 420. For example, when the validity generator 415 generates the “enable signal,” the history accumulator 425 may request converged coefficient C_{K} and non-linear term correlation matrix H^{H}H_{K} from the subset extractor 420, thus triggering the subset extractor 420 to obtain the most recently generated coefficient from the DPD estimator 310 and corresponding correlation matrix H^{H}H_{K}. Alternatively, the DPD estimator 310 may be programmed to automatically send converged coefficients C_{K} and H^{H}H_{K} to the CPE estimator 400.

As described above, the non-linear term correlation matrix is a matrix that describes how the output error of generalized memory polynomial model (e.g., Equation 1) changes as the DPD coefficient cᵢ changes. Also, as described above, the coefficient vector cᵢ is a set of values (e.g., coefficients) that represent the strength of different non-linear terms in the generalized memory polynomial model used to correct non-linearities of the PA 210. These coefficients are used to calculate the pre-distorted signal x_{DPD}(n) fed into the PA 210.

The subset extractor 420 extracts a subset (R_{sub}) of the non-linear term correlation matrix H_{K}^{H}H_{K} and extracts a subset (C_{sub}) of a projected coefficient vector. The subset extractor 420 is to generate the projected coefficient vector, using the converged coefficient vector c_{K}, based on multiplying the correlation matrix H_{K}^{H}H_{K} of profile k with the coefficient vector c_{K} of profile k. Therefore, the projected coefficient vector (c_{SUB}) is represented as H_{K}^{H}H_{K}c_{K}. In some examples, the subsets R_{SUB} and C_{SUB} correspond to key terms in the non-linear term correlation matrix H^{H}H that are important or critical in performance of the DPD estimator 310. For example, the DPD model defining an inverse function has a −50 dBc ACLR performance, where dBc is a unit of measurement that expresses the power level of the output signal in an adjacent band relative to the power of the output signal in the assigned band. A lower dBc value indicates a weaker signal. The subset extractor 420 extracts terms from the non-linear term correlation matrix H^{H}H and the projected coefficient vector, corresponding to coefficient vector C_{K}, that will still contribute to a high performance of the DPD model. For example, the subset extracted may produce only a minor degrade in performance (e.g., −48 dBc performance rather than −50 dBc performance) of the DPD model. In some examples, the subset extractor 420 selects which terms are critical for performance of the DPD estimator 310 based on DPD model pruning techniques that decide which terms to remove from the full model for minimal performance impact. The subset extractor 420 extracts the subsets R_{SUB} and C_{SUB} when the non-linear term correlation matrix H^{H}H has a high number of terms relative to the ideal memory usage of the CPE estimator 400. For example, a non-linear term correlation matrix H^{H}H and a corresponding coefficient vector C_{K} may use a certain percentage above the allotted memory for the C_{CPE}, and the subset extractor 420 reduces that memory usage while maintaining a minimum performance of the DPD model by extracting key terms from the non-linear term correlation matrix H^{H}H and the projected coefficient vector corresponding to the converged coefficient C_{K}.

In the illustrated example of FIG. 4, the history accumulator 425 is to accumulate R_{SUB} and C_{SUB} with previously stored and accumulated R_{SUB} and C_{SUB}. The previously stored R_{SUB} and C_{SUB} correspond to different profile types that have been observed by the profile identifier 405 and that have caused convergence of the output signal y(n) with the input signal x(n). For example, the history accumulator 425 may store a first R_{SUB} and C_{SUB} corresponding to the first profile 105 (FIG. 1A) and a second R_{SUB} and C_{SUB} corresponding to the second profile 110 (FIG. 1A). In such an example, the history accumulator 425 stores an accumulated C_{SUB}, corresponding to a combination (or an accumulation) of the first C_{SUB} and second C_{SUB}, and stored an accumulated R_{SUB}, corresponding to an accumulation of the first R_{SUB} and the second R_{SUB}. The history accumulator 425 may be triggered by the validity generator 415 to accumulate R_{SUB} and C_{SUB} with previously accumulated R_{SUB} and C_{SUB}. For example, the R_{SUB} and C_{SUB} may be a third R_{SUB} and a third C_{SUB} corresponding to the third profile 115 (FIG. 1A). In such an example, the history accumulator 425, when prompted by an “enable” signal from the validity generator 415, accumulates the third R_{SUB} with the accumulated R_{SUB} and accumulates the third C_{SUB} with the accumulated C_{SUB}.

In some examples, the history accumulator 425 clears or removes the accumulated R_{SUB} and C_{SUB} when the time or temperature drifts beyond the threshold described above. For example, the history accumulator 425 may be triggered by a “clear” signal from the validity generator 415 to reset the accumulated R_{SUB} and C_{SUB}, because those accumulated coefficients and term correlation matrices may no longer accurately reflect the non-linearity of the PA 210. Therefore, the coefficients are to be reset and updated when time or temperature drifts.

In some examples, the subset extractor 420 does not extract subsets R_{SUB} and C_{SUB} of the non-linear term correlation matrix H^{H}H or the projected coefficient vector, corresponding to converged coefficient C_{K}. For example, the history accumulator 425 accumulates the whole projected coefficient vector, corresponding to the converged coefficient C_{K}, and correlation matrix H_{K}^{H}H_{K} with previously accumulated projected coefficient vectors and correlation matrices. For example, a non-linear term correlation matrix H^{H}H and a corresponding projected coefficient vector may use a certain percentage below the allotted memory for the C_{CPE}, and the subset extractor 420 does not need to reduce that memory usage. In such an example, the subset extractor 420 forwards the full non-linear term correlation matrix H^{H}H and the projected coefficient vector, corresponding to the converged coefficient C_{K}, to the history accumulator 425.

In the illustrated example of FIG. 4, the combined profile estimate (CPE) generator 430 is to combine the accumulated R_{SUB} and the accumulated C_{SUB} to generate the CPE coefficient C_{CPE}. For example, the CPE generator 430 may implement Equation 3 to generate the C_{CPE}.

$${c}_{CPE} = {( {\sum }_{k} {R}_{sub , k} )}^{- 1} ( {\sum }_{k} {c}_{sub , k} ) \qquad Equation 3$$

In Equation 3, R_{sub,k} refers to the subset of the non-linear term correlation matrix

$${H}_{k , s}^{H} {H}_{k , s}$$

and c_{sub,k} refers to the subset of the projected coefficient vector

$${H}_{k , s}^{H} {H}_{k} {c}_{k} ,$$

where

$${H}_{k , s}^{H}$$

is a submatrix of Hₖ with columns of subset of the non-linear terms. In Equation 3, R_{SUB} and C_{SUB} of k profiles are accumulated to generate the C_{CPE}.

By waiting for a profile change and waiting for convergence to occur for that profile, the C_{CPE} is estimated non-iteratively, as opposed to the coefficient vector generated by the DPD estimator 310, which is estimated iteratively. In some examples, the CPE generator 430 provides C_{CPE} to the coefficient selector 320 for the next time the profile change detector 305 detects a profile change in the input signal x(n).

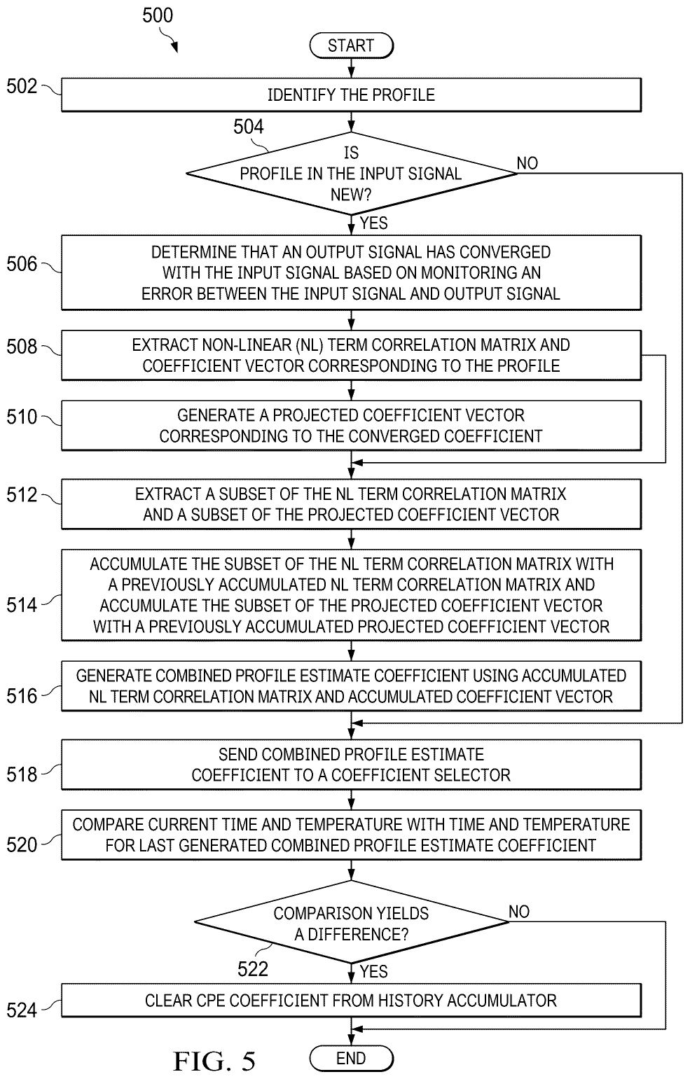

FIG. 5 is a flowchart of embodiment method 500, according to an embodiment of the present disclosure. Method 500 may be executed, instantiated, or performed by example programmable circuitry to implement the CPE estimator 400 of FIG. 4.

Method 500 begins at block 502, at which the profile identifier 405 identifies the profile. For example, the profile identifier 405 categorizes the input signal into a profile bin or profile type based on the frequency analysis of the input signal x(n) over a time window. In some examples, the profile identifier 405 categorizes the profile of input signal x(n) as a first profile when the input signal x(n) has a power around 47.5 dBm and is transmitted signal over nearly a 20 MHz transmission bandwidth. In some examples, the profile identifier 405 categorizes the profile of input signal x(n) as a second profile when the input signal x(n) has a PSD corresponding to a power of 44.5 dBm transmitted over a 10 MHz transmission bandwidth. The profile identifier 405 may categorize the profile of the input signal x(n) in any manner not described above.

At block 504, the validity generator 415 determines whether the profile of the input signal is new. For example, the validity generator 415 determines whether a combined profile estimate coefficient C_{CPE} is to be updated or generated based on whether the history accumulator 425 has coefficients corresponding to the profile and, thus, whether the history accumulator 425 has already applied coefficients of the profile to the C_{CPE}. As mentioned above, the C_{CPE} is a coefficient that represents a combination of coefficient values corresponding to all the signal profiles that have been observed. The C_{CPE} provides a reasonable coefficient starting point for DPD estimation, when the signal profile changes, that does not increase at least one of an adjacent channel leakage ratio (ACLR) or an error vector magnitude (EVM) in the output signal y(n) generated by PA 210. Therefore, if the validity generator 415 determines that a profile is not new or has been previously observed, then the C_{CPE} already includes coefficient values representing that profile. As such, block 504 returns a value NO and control turns to block 518 where the combined profile estimate generator 430 sends the current C_{CPE} to the coefficient selector 320.

Alternatively, if the validity generator 415 determines that the profile in the input signal is new (e.g., block 504 returns a value YES), the error monitor 410 determines that an output signal has converged with the input signal based on monitoring an error between the input signal and output signal (block 506). For example, the error monitor 410 compares the input signal x(n) to the feedback signal L{Y(n)} to determine when a threshold amount of error exists between the input signal x(n) to the feedback signal L{Y(n)}, the error threshold indicative of a small enough difference between the two signals to satisfy convergence.

At block 508, the subset extractor 420 extracts the nonlinear term correlation matrix H^{H}H and coefficient vector C_{K} corresponding to the profile. For example, the subset extractor 420 waits until the output signal y(n) converges with the input signal x(n) after the profile change, and extracts the DPD coefficient from the DPD estimator 310 that caused convergence between the two signals. Also, the subset extractor 420 extracts the matrix H^{H}H corresponding to the converged coefficient C_{K} from the DPD estimator 310. The subset extractor 420 does not extract every DPD coefficient used during DPD estimation to reach convergence. For example, if it took five iterations of DPD estimation and, thus, five DPD coefficients to reach convergence, the subset extractor 420 extracts the fifth DPD coefficient.

At block 510, the subset extractor 420 generates a projected coefficient vector corresponding to the converged coefficient C_{K}. For example, the subset extractor 420 multiplies the non-linear term correlation matrix H^{H}H_{K} with the converged coefficient c_{K} to obtain the projected coefficient vector H^{H}H_{K}c_{K}.

At block 512, the subset extractor 420 extracts a subset R_{SUB} of the non-linear term correlation matrix and extracts a subset C_{SUB} of a projected coefficient vector H^{H}H_{K}c_{K}. In some examples, the subset extractor 420 implements DPD model pruning techniques to identify the key terms in the non-linear term correlation matrix H^{H}H and the coefficient vector C_{K}, the key terms to be extracted as the subset.

At block 514, the history accumulator 425 accumulates the subset of the NL term correlation matrix with a previously accumulated NL term correlation matrix and accumulates the subset of the projected coefficient vector with a previously accumulated projected coefficient vector. For example, the history accumulator 425 is triggered by the validity generator 415 to accumulate R_{SUB} and C_{SUB} with previously accumulated R_{SUB} and C_{SUB}, the previously accumulated R_{SUB} and C_{SUB} corresponding to different signal profiles than the current R_{SUB} and C_{SUB}. To accumulate R_{SUB} and C_{SUB} with previously accumulated R_{SUB} and C_{SUB}, the history accumulator 425 may multiply values in the current R_{SUB} with values in the accumulated R_{SUB}, and multiply values in the current C_{SUB} with values in the accumulated C_{SUB}. As such, the size of R_{SUB} does not change and the size of C_{SUB} does not change, just the values of R_{SUB} and C_{SUB} change.

At block 516, the combined profile estimate generator 430 generates the combined profile estimate coefficient C_{CPE} using the accumulated NL term correlation matrix and accumulated projected coefficient vector. For example, the CPE generator 430 may implement Equation 3 above (c_{CPE}=(ΣₖR_{sub,k})⁻¹(Σₖc_{sub,k})) to generate the C_{CPE}, using the accumulated R_{SUB} and accumulated C_{SUB}.

At block 518, the combined profile estimator generator 430 sends the combined profile estimate coefficient C_{CPE} to the coefficient selector 320. For example, the CPE generator 430 sends the C_{CPE} to an input of a multiplexer, where the multiplexor is to select the C_{CPE} to send to the input of the DPD corrector circuitry 215 when a profile change is detected in the input signal x(n). In some examples, the DPD corrector circuitry 215 is to use the C_{CPE} once to minimize an error between x(n) and y(n) when the profile change is detected.

As described above, when the validity generator 415 determines that the profile has been previously observed and accounted for, (e.g., block 504 returns a value NO), the CPE generator 430 provides the current C_{CPE} to the coefficient selector 320, skipping the accumulation step. For example, an updated or new C_{CPE} does not need to be generated for the identified profile.

At block 520, the validity generator 415 compares the current time and temperature with the time and temperature for the last generated C_{CPE}. For example, the validity generator 415 compares the current temperature of the PA 210 with the temperature of the PA 210 when the CPE generator 430 last updated C_{CPE}. Additionally, the validity generator 415 receives a time signal indicative of whether timer 325 has completed a cycle, the cycle beginning when the C_{CPE} is generated (or updated) and ending when the threshold length of time has been met.

At block 522, the validity generator 415 determines whether the comparison yields a difference. For example, the validity generator 415 determines whether the temperature has drifted beyond the threshold temperature difference, the threshold temperature difference indicative of a minimum amount of change in temperature that would cause the coefficients (e.g., the CPE coefficients, the DPD coefficients, etc.) to be inaccurate. Also, the validity generator 415 determines whether the timer 325 has completed the cycle.

When the validity generator 415 determines the comparison does not yield a difference (e.g., block 522 returns a value NO), the operations 500 end. For example, the validity generator 415 does not need to update or reset the C_{CPE} because the current C_{CPE} is likely still accurate.

When the validity generator 415 determines the comparison does yield a difference (e.g., block 522 returns a value YES), the history accumulator 425 clears the CPE coefficient C_{CPE} from the history accumulator 425. For example, the validity generator 415 generates a “clear” signal that triggers the history accumulator 425 to reset C_{CPE} because C_{CPE} may inaccurately represent the non-linearity of the PA 210 due to the time or temperature drifts. The clear signal additionally clears accumulated R_{SUB} and C_{SUB}.

Example methods are described with reference to the flowchart illustrated in FIG. 5. However, many other methods of implementing the CPE estimator 400 of FIG. 4 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples. In some examples, the operations 500 of FIG. 5 may be used for implementing the PACS generator 315 of FIG. 3.

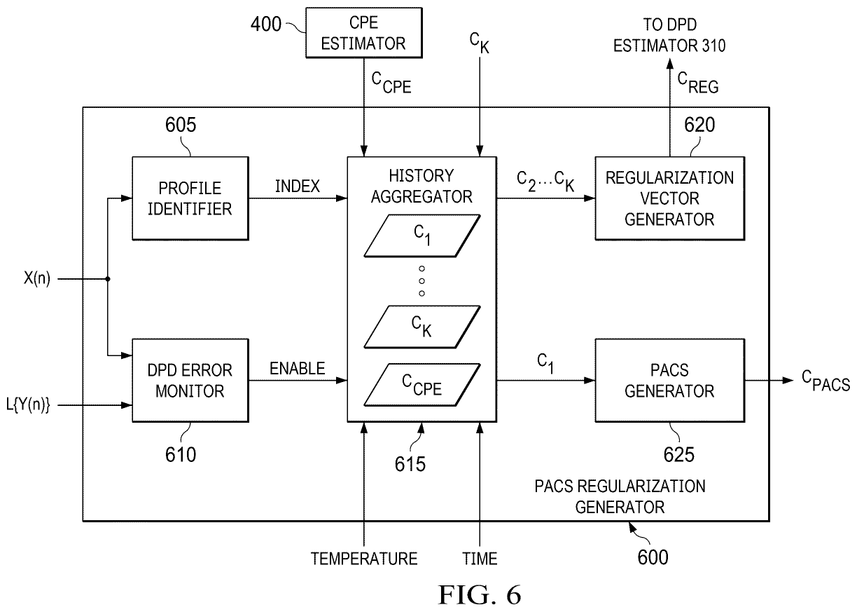

FIG. 6 is a block diagram of an example profile agnostic coefficient set (PACS) regularization generator 600, according to an embodiment of the present disclosure. The PACS regularization generator 600 is an example implementation of the PACS generator 315 of FIG. 3, where the PACS generator 315 implements the CPE estimator 400 and the PACS regularization generator 600 to generate a profile agnostic coefficient that can be used for DPD estimation when the profile changes in the input signal. In the illustrated example of FIG. 6, the PACS regularization generator 600 includes a profile identifier 605, an error monitor 610, a history aggregator 615, a regularization vector generator 620, and a PACS generator 625.

In some examples, the PACS regularization generator 600 may be implemented by the DPD coefficient estimation system 220 with the CPE estimator 400 to improve the way that the DPD estimator 310 estimates coefficients for a given input signal x(n). For example, the PACS regularization generator 600 generates a regularization vector that controls or impacts weights used by the DPD estimator 310 when estimating coefficients. The regularization vector has information corresponding to a set of profiles, where the set of profiles is different than a profile used to as the PACS coefficient. In some examples, the PACS regularization generator 600 may be implemented by the DPD coefficient estimation system 220 without the CPE estimator 400. The regularization vector is described in further detail below.

In the illustrated example of FIG. 6, the profile identifier 605 and the error monitor 610 operate the same as or substantially the same as the profile identifier 405 and the error monitor 410 of the CPE estimator 400 of FIG. 4. For example, the profile identifier 605 receives samples of the input signal x(n) and uses frequency analysis to identify the profile of the input signal x(n). The error monitor 610 compares the input signal x(n) to the feedback signal L{y(n)} to determine whether convergence between the output signal y(n) and the input signal x(n) has occurred.

In some examples, the profile identifier 605 is to generate an “index” signal based on whether a new profile is detected. For example, when the profile identifier 605 detects a signal profile change from a first profile to a second profile, and the second profile has not yet been observed by the profile identifier 605 or has been observed, the profile identifier 605 generates an “index” signal. The “index” signal triggers the history aggregator 615 to extract the converged coefficient C_{K} from the DPD estimator 310 and the updated C_{CPE} from the CPE estimator 400 and store C_{K} and C_{CPE} or replace the previously stored C_{K} corresponding to the second profile with the new C_{K}.

In some examples, the DPD error monitor 610 is to generate an “enable” signal when convergence occurs. In some examples, the history aggregator 616 uses the “enable” signal in conjunction with the “index” signal. For example, when the profile identifier 605 generates an “index” signal, the history aggregator 615 waits until the DPD error monitor 610 generates the “enable” signal to extract the converged coefficient C_{K} and replace a previously stored C_{K} with the most recently converged coefficient C_{K}. This is because the “enable” signal informs the history aggregator 615 that a converged coefficient C_{K} exists for the profile.

In the illustrated example of FIG. 6, the history aggregator 615 stores converged coefficients corresponding to profiles 1-k (C₁-C_{K}), and stores the combined profile estimate coefficient C_{CPE} in response to signals from the profile identifier 605, the DPD error monitor 610, and the CPE estimator 400. In some examples, the history aggregator 615 responds to requests from the regularization vector generator 620 and the PACS generator 625. For example, the history aggregator 615 may provide requested coefficients to the regularization vector generator 620 and a requested coefficient to the PACS generator 625. In some examples, the history aggregator 615 is a database configured to store DPD coefficients. For example, the history aggregator 615 is implemented by any memory, storage device and/or storage disc for storing data such as, for example, flash memory, magnetic media, optical media, solid state memory, hard drive(s), thumb drive(s), etc. Furthermore, the data stored in the history aggregator 615 may be in any data format such as, for example, binary data, comma delimited data, tab delimited data, etc. While, in the illustrated example, the history aggregator 615 is illustrated as a single device, the history aggregator 615 and/or any other data storage devices described herein may be implemented by any number and/or type(s) of memories. In some examples, the history aggregator 615 replaces previously stored C_{CPE} with updated C_{CPE} in response to a notification from the CPE estimator 400.

In some examples, the history aggregator 615 clears respective stored DPD coefficients when the temperature of the PA 210 drifts beyond a threshold temperature difference or when the threshold length of time is satisfied. For example, the history aggregator 615 receives the measured temperature of the PA 210 and receives a signal from the timer 325. In some examples, the history aggregator 615 compares the measured temperature of the PA 210 to a recorded temperature of the PA 210 when the last C_{CPE} was generated or the last converged coefficient was generated. In some examples, the history aggregator 615 evicts a stored DPD coefficient from the history aggregator 615 when the difference between the measured temperature of the PA 210 and the previously recorded temperature of the PA 210 when the particular converged coefficient (c₁, c_{K}) was generated exceeds or satisfies a threshold temperature difference. Additionally, in some examples, the history aggregator 615 evicts the stored DPD coefficient from the history aggregator 615 when the timer 325 indicates that a cycle corresponding to the last generated coefficient is complete.

In the illustrated example of FIG. 6, the regularization vector generator 620 is to generate a regularization vector C_{REG} based on a predetermined regularization method. A predetermined regularization method refers to a method for error minimization, where the error signal not only includes the error between the input signal x(n) and the output signal y(n) but also includes a weighted error between the current DPD coefficient and the regularization vector C_{REG}. “Error minimization” is the same as “non-linear optimization” and is performed by the DPD estimator 310 to generate a DPD coefficient cᵢ. In some examples, a first regularization method performs error minimization on a highest power profile while regularizing the error minimization towards lower power profiles. A second regularization method performs error minimization on a lowest power profile while regularizing the error minimization towards higher power profiles. A third regularization method performs error minimization on a highest power profile while regularizing the error minimization towards the profiles used to generate the C_{CPE}. While three predetermined regularization methods are described, any number of predetermined regularization methods may be used by the regularization vector generator 620 to improve DPD estimation when the profile of the input signal x(n) changes. In some examples, the regularization vector C_{REG} improves DPD estimation by influencing the DPD estimator 310 to output a solution (cᵢ) to be closer to a reference solution that will have some other properties of being accurate across different profiles.

In the illustrated example of FIG. 6, the regularization vector generator 620 implements the first regularization method and generates C_{REG} to be a combination of converged coefficients corresponding to every observed profile except the profile corresponding to the highest observed power. For example, if the highest power profile observed is a 50 dBm input signal x(n) categorized as profile 1 (C₁), then the regularization vector generator 620 requests coefficients from the history aggregator 615 corresponding to profiles indicative of powers less than 50 dBm. In this example, those profiles indicative of powers less than 50 dBm are categorized as profiles 2-k and, thus, the corresponding coefficients are C₂-C_{K}. In some examples, the regularization vector generator 620 accumulates the coefficients C₂-C_{K} to generate the regularization vector C_{REG}. Alternatively, the regularization vector generator 620 combines the coefficients C₂-C_{K} in any manner to generate C_{REG}. The regularization vector generator 620 sends C_{REG} to the DPD estimator 310.

In examples where the regularization vector generator 620 implements the second regularization method, C_{REG} is a combination of converged coefficients corresponding to every observed profile except the profile corresponding to the lowest observed power. For example, if the lowest power profile observed is a 10 dBm input signal x(n) categorized as profile 1 (C₁), then the regularization vector generator 620 requests coefficients from the history aggregator 615 corresponding to profiles indicative of powers greater than 10 dBm. In this example, those profiles indicative of powers greater than 10 dBm are categorized as profiles 2-k and, thus, the corresponding coefficients are C₂-C_{K}.

In examples where the regularization vector generator 620 implements the third regularization method, C_{REG} is a combination of converged coefficients corresponding to every observed profile. For example, the regularization vector generator 620 requests the combined profile estimate coefficient C_{CPE} from the history aggregator 615.

In the illustrated example of FIG. 6, the PACS generator 625 is to generate a profile agnostic coefficient set (PACS) C_{PACS} based on the predetermined regularization method. For example, if the PACS generator 625 and the regularization vector generator 620 implement the first regularization method, the PACS generator 625 extracts or requests the coefficient corresponding to the highest observed power profile. If the PACS generator 625 and the regularization vector generator 620 implement the second regularization method, the PACS generator 625 extracts or requests the coefficient corresponding to the lowest observed power profile. If the PACS generator 625 and the regularization vector generator 620 implement the third regularization method, the PACS generator 625 extracts or requests the coefficient corresponding to the highest observed power profile.

In an example operation of the regularization vector generator 620 and the PACS generator 625, assume that the first regularization method is implemented, and that the profile of the input signal x(n) has changed from a first profile to a second profile. The PACS generator 625 requests, from the history aggregator 615, the coefficient corresponding to the highest power profile and sends that coefficient as C_{PACS} to the coefficient selector 320. Simultaneously, the regularization vector generator 620 may request, from the history aggregator 615, the coefficients corresponding to the lower power profiles and generates C_{REG} based on those coefficients. The regularization vector generator 620 sends C_{REG} to the DPD estimator 310.

In the example operation, the profile change detector 305 outputs a logic 1 and selects the C_{PACS} to forward to the DPD corrector circuitry 215, where the DPD corrector circuitry 215 uses C_{PACS} for the first iteration of DPD estimation. After the DPD corrector circuitry 215 applies C_{PACS} to the pre-distorted the input signal x(n), the output signal y(n) represents the input signal x(n), with some error e. The DPD estimator 310 then applies error minimization (or non-linear optimization) in a next iteration using C_{PACS} as cₜ₋₁, because C_{PACS} is the parameter vector used at the previous iteration or time step t−1. Additionally, to decrease the error e observed with C_{PACS}, the DPD estimator 310 applies the regularization vector C_{REG} to the non-linear optimization problem. For example, the regularization-based non-linear optimization problem is illustrated below in Equation 4.

$${c}_{t} = {c}_{t - 1} + {( {H}^{H} H + {λ}_{reg} I )}^{- 1} ( {H}^{H} e - {λ}_{reg} ( {c}_{t - 1} - {c}_{reg} ) ) \qquad Equation 4$$

In Equation 4, cₜ is a DPD coefficient c at a current iteration or time step t that is being optimized by the non-linear optimization problem to improve the generalized memory polynomial model of Equation 1, cₜ₋₁ is the parameter vector c at the previous iteration or time step t−1, H^{H}H represents the non-linear term correlation matrix, λ_{reg} is a regularization weight, I is an identity matrix, and c_{reg} is the regularization vector generated by the regularization vector generator 620. In some examples, because the regularization vector and the regularization weight correspond to signal profiles different than the signal profile of C_{PACS}, the DPD estimator 310 is able to more efficiently optimize the DPD coefficient to accurately reflect the non-linearity of the PA 210 across all input profiles.

In the example operation, the profile change detector 305 outputs a logic 0 to the coefficient selector 320 in response to the DPD corrector circuitry 215 applying C_{PACS} to the first iteration of digital pre-distortion. The logic 0 triggers the coefficient selector 320 to select the output of the DPD estimator 310. In this example, the output of the DPD estimator 310 is a DPD coefficient cᵢ (or cₜ) regularized towards low power profiles.

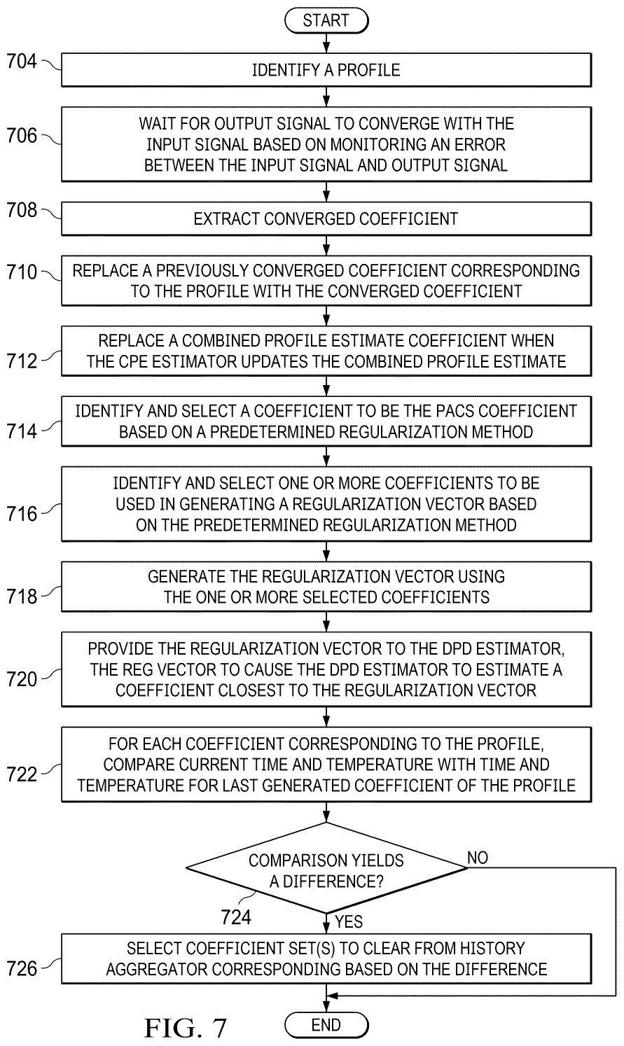

FIG. 7 is a flowchart of embodiment method 700, according to an embodiment of the present disclosure. Method 700 may be executed, instantiated, or performed by example programmable circuitry to implement the PACS regularization generator 600 of FIG. 6.

Method 700 begins at block 704, at which the profile identifier 605 identifies the profile. For example, for each sample of the input signal x(n), the profile identifier 605 categorizes the input signal into a profile bin or profile type based on the frequency analysis of current input samples over a time window. In some examples, the profile identifier 605 categorizes the profile of input signal x(n) as a first profile when the input signal x(n) has a PSD corresponding to a power of, e.g., 47.5 dBm transmitted over, e.g., a 20 MHz transmission bandwidth. In some examples, the profile identifier 605 categorizes the profile of input signal x(n) as a second profile when the input signal x(n) has a PSD corresponding to a power of, e.g., 44.5 dBm transmitted over a, e.g., 10 MHz transmission bandwidth. The profile identifier 605 may categorize the profile of the input signal x(n) in any manner not described above.

At block 706, the error monitor 610 waits for an output signal to converge with the input signal based on monitoring an error between the input signal and output signal. For example, the DPD error monitor 610 compares the input signal x(n) to the feedback signal L{Y(n)} to determine when a threshold amount of error exists between the input signal x(n) to the feedback signal L{Y(n)}, the error threshold indicative of a small enough difference between the two signals to satisfy convergence.

At block 708, the history aggregator 615 extracts the converged coefficient vector C_{K} corresponding to the profile. For example, the history aggregator 615 receives an “enable” signal from the DPD error monitor 610 and an “index” signal from the profile identifier 605 and extracts the DPD coefficient C_{K} from the DPD estimator 310 that caused convergence between the two signals.

At block 710, the history aggregator 615 replaces a previously stored converged coefficient corresponding to the profile with the converged coefficient. In an example where the history aggregator 615 stores a coefficient for profile k (C_{K}), and the profile identifier 605 identifies profile k in the input signal x(n), and a converged coefficient has been generated for the profile k, the profile identifier 605 replaces the previously stored coefficient vector C_{K} with the newly generated converged coefficient.

At block 712, the history aggregator 615 replaces a combined profile estimate coefficient C_{CPE} when the CPE estimator 400 updates the combined profile estimate. In some examples, the C_{CPE} is updated because the profile of the input signal x(n) is new or, otherwise, has not been observed yet.

At block 714, the PACS generator 625 identifies and selects a coefficient to be the PACS coefficient based on a predetermined regularization method. For example, based on which regularization method the PACS generator 625 and the regularization vector generator 620 implement, the PACS generator 625 requests a coefficient corresponding to a high power profile, a low power profile, etc., from the history aggregator 615.

At block 716, the regularization vector generator 620 identifies and selects one or more coefficients to be used in generating a regularization vector C_{REG} based on the predetermined regularization method. For example, the regularization vector generator 620 requests the history aggregator 615 to provide coefficients corresponding to profiles different than the profile represented by C_{PACS}. In some examples, the regularization vector generator 620 requests the history aggregator 615 to provide the C_{CPE}.

At block 718, the regularization vector generator 620 generates the regularization vector using the one or more selected coefficients. For example, the regularization vector generator 620 accumulates the one or more selected coefficients to generate C_{REG}.

At block 720, the regularization vector generator 620 provides the regularization vector C_{REG} to the DPD estimator 310, the regularization vector C_{REG} to cause the DPD estimator 310 to estimate a coefficient cᵢ closest to the regularization vector C_{REG}. For example, the DPD estimator 310 implements Equation 4 above, which uses regularization vector C_{REG} to optimize the coefficient cᵢ.

At block 722, the history aggregator 615, for each coefficient corresponding to the profile, compares the current time and temperature with the time and temperature for the last generated coefficient of the profile. For example, the history aggregator 615 compares the current temperature of the PA 210 with the temperature of the PA 210 when the converged coefficient for the identified profile was generated or when the C_{CPE} was last updated. Additionally, the history aggregator 615 receives a time signal indicative of whether timer 325 has completed a cycle, the cycle beginning when the converged coefficient of the profile was generated or when the C_{CPE} was generated (or updated) and ending when the threshold length of time has been met.

At block 724, the history aggregator 615 determines whether the comparison yields a difference. For example, the history aggregator 615 determines whether the temperature has drifted beyond the threshold temperature difference, the threshold temperature difference indicative of a minimum amount of change in temperature that would cause the coefficients (e.g., the CPE coefficients, the DPD coefficients, etc.) to be inaccurate. Also, the history aggregator 615 determines whether the timer 325 has completed the cycle.

When the history aggregator 615 determines the comparison does not yield a difference (e.g., block 724 returns a value NO), the operations 700 end. For example, the history aggregator 615 does not need to update or reset the C_{CPE} because the current C_{CPE} is likely still accurate and does not need to replace the converged coefficient C_{K} because the C_{K} is likely still accurate.

When the history aggregator 615 determines the comparison does yield a difference (e.g., block 724 returns a value YES), the history aggregator 615 selects coefficient set(s) to clear from the history aggregator 615 based on the difference. For example, if the history aggregator 615 determines that the C_{CPE} was generated too long ago, the history aggregator 615 clears the CPE coefficient C_{CPE}. In some examples, if the history aggregator 615 determines that the coefficient of profile 1 C₁ was generated when the PA 210 was a first temperature and now the PA 210 is a second temperature significantly different than the first temperature, the history aggregator 615 clears C₁ because C₁ may inaccurately represent the non-linearity of the PA 210 due to the temperature drifts.

Example methods are described with reference to the flowchart illustrated in FIG. 7. However, many other methods of implementing the PACS regularization generator 600 of FIG. 6 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples. In some examples, the operations 700 of FIG. 7 may be used for implementing the PACS generator 315 of FIG. 3.

FIG. 8 is a block diagram of the example DPD estimator 310 of FIG. 3, according to an embodiment of the present disclosure. In the example of FIG. 8, the DPD estimator 310 includes a capture engine 805, coefficient update circuitry 810, a profile change rate detector 815, a signal statistics analyzer 820, and a DPD iteration controller 825.

In the illustrated example of FIG. 8, the capture engine 805 captures samples of the input signal x(n) and samples of the feedback signal L{y(n)}, the samples to be used to update the DPD coefficient cᵢ. For example, the samples of the input signal x(n) and the samples of the feedback signal L{y(n)} are used to generate the error vector e in Equations 2 or 4. The samples of the two signals provide information regarding the difference, if any, between the two signals. In some examples, the capture engine 805 captures samples of the input signal x(n) and the feedback signal L{y(n)} for a sampling period. For example, the capture engine 805 may be configured to capture a fixed number of samples, where the fixed number of samples is sufficient to update the next iteration of the DPD coefficient cᵢ. In some examples, the capture engine 805 captures the samples based on tapping off data from an incoming data stream into a memory for later processing. In some examples, the DPD iteration controller 825 controls the number of samples captured. For example, the DPD iteration controller 825 instructs the capture engine 805 to capture more samples than captured, as described in further detail below.

In the illustrated example of FIG. 8, the DPD estimator 310 includes the coefficient update circuitry 810 to generate DPD coefficients cᵢ. As mentioned above, the DPD coefficients cᵢ are updated iteratively, where it takes 3-5 iterations of DPD coefficient updates to cause convergence between the output signal y(n) and the input signal x(n). In some examples, the coefficient update circuitry 810 updates the DPD coefficient cᵢ when a fixed number of samples are captured. For example, the coefficient update circuitry 810 applies Equation 2, or 4 above, every time the capture engine 805 captures a fixed number of samples of the input signal x(n) and samples of the feedback signal L{y(n)}. In some examples, the capture engine 805 starts capturing samples when a DPD coefficient cᵢ₋₁ is generated and ends when the fixed number of samples are obtained. In some examples, when the profile change rate is indicative of a frequent profile changing scenario, the capture engine 805 captures a maximum number of samples in order to relax an update criteria for the coefficient cᵢ. In some examples, the coefficient update circuitry 810 is instructed to not update the DPD coefficient cᵢ when fixed number or maximum number samples are captured. For example, the DPD iteration controller 825 triggers the coefficient update circuitry 810 to update or retain the DPD coefficient cᵢ, based on how fast the profile of the input signal x(n) is changing. In some examples, the coefficient update circuitry 810 applies Equation 2 to update the DPD coefficient cᵢ. In some examples, the coefficient update circuitry 810 applies Equation 2 to update the DPD coefficient cᵢ. For example, the coefficient update circuitry 810 uses Equation 2 when the DPD coefficient estimation system 220 and the PACS generator 315 implement only the CPE estimator 400 of FIG. 4, rather than both the CPE estimator 400 and PACS regularization generator 600 of FIG. 6. In some examples, the coefficient update circuitry 810 uses Equation 4 when the PACS generator 315 implements both the CPE estimator 400 and PACS regularization generator 600. Equation 4 optimizes the DPD coefficient cᵢ based on regularization vector C_{REG} and regularization weight.

In the illustrated example of FIG. 8, the DPD estimator 310 includes the example profile change rate detector 815 to detect a change rate of the profile in the input signal x(n). In some examples, the profile change rate (PCR) detector 815 computes the profile change rate from the number of profile changes in a period of time (e.g., 20 seconds, 30 seconds, etc.) by comparing statistics (e.g., power spectral density, bandwidth, etc.) of consecutive short time period blocks (e.g., 200 ms blocks, 100 ms blocks, etc.). For example, the PCR detector 815 may be configured to sample and analyze the input signal x(n) over 200 ms blocks to determine a statistic of the input signal x(n) over that time period. The PCR detector 815 then compares the statistics obtained per block after 20 seconds of sampling and analyzing. In such an example, the PCR detector 815 obtains 10 statistics in the 20 seconds, where the 10 statistics may be the same or may be different. In some examples, the PCR detector 815 determines the profile change rate by counting how many times the statistics (e.g., levels of bandwidth or power) changed during the time period. In some examples, the PCR detector 815 compares the profile change rate, indicated by the counted number of times the statistics changed, to a threshold profile change rate α. In some examples, the threshold profile change rate α is indicative of changes faster than digital pre-distortion convergence time. For example, the PCR detector 815 operates to determine whether the input signal x(n) is changing in profile frequently, where “frequently” is relative to how fast the DPD estimator 310 and DPD corrector circuitry 215 cause the output signal y(n) to converge with the input signal x(n). In some examples, when the profile of the input signal x(n) changes faster than the DPD corrector circuitry 215 can converge the output signal y(n) to the input signal x(n), updating the DPD coefficient cᵢ iteratively, based on the profile, may be inefficient because the profile will change before convergence, and cᵢ may not minimize error between the output signal y(n) and the input signal x(n). However, controlling when the coefficient cᵢ is updated based on all or a subset of the profiles of the input signal x(n) may provide a steady output state of the output signal y(n). Therefore, the PCR detector 815 sends an “enable” signal when the profile change rate exceeds the profile change rate threshold α to trigger the DPD iteration controller 825 to control when the next iteration of coefficient estimation cᵢ is computed.

In the illustrated example of FIG. 8, the signal statistics analyzer 820 is to analyze the statistics of the input signal x(n), where the statistics includes the power and bandwidth of the input signal x(n). In some examples, while the PCR detector 815 counts how many times the statistics (e.g., levels of bandwidth or power) changed during the time period, the signal statistics analyzer 820 identifies the profiles of each time period block. For example, the signal statistics analyzer 820 analyzes the input signal x(n) in consecutive short time period blocks over a length of time. In the example above, the signal statistics analyzer 820 identifies the profile of the input signal x(n) 100 times over a 20 second length of time. In such an example, the signal statistics analyzer 820 may identify 100 different profiles, where the input signal x(n) changed to a different profile every 200 ms, or the signal statistics analyzer 820 may identify 2 different profiles, where the input signal x(n) changed back and forth between 2 profiles every 200 ms, every 400 ms, etc. The signal statistics analyzer 820 outputs a list of the profiles (profiles k) observed during the length of the time. For example, the signal statistics analyzer 820 may output the PSDs observed during 20 seconds (e.g., 44.5 dBm/Hz, 47.5 dBm/Hz, 40.5 dBm/Hz, etc.), may output decibels relative to full scale (dBFS) observed during 20 seconds (e.g., −8.5 dBFS, −13.5 dBFS, −18.5 dBFS, etc.), may output transmission bandwidths observed (e.g., 20 MHz, 10 MHz, 5 MHz, etc.), or any other statistic of the input signal x(n). As used herein, dBFS measures how far an amplitude of the input signal x(n) is below the peak amplitude. Decibels relative to full scale is expressed as a negative number relative to the maximum level available in the transmitter circuitry 200. In some examples, dBFS is another way to represent the power of the input signal x(n).

In some examples, the signal statistics analyzer 820 selects a subset profile list of the list of profiles that the signal statistics analyzer 820 identifies. For example, the signal statistics analyzer 820 selects 2, 3, 4 or any number of profiles in the list to represent the list of k profiles. In some examples, the signal statistics analyzer 820 selects the two highest observed profiles to be the subset. For example, if the signal statistics analyzer 820 identifies powers −8.5 dBFS, −13.5 dBFS, and −18.5 dBFS in the input signal x(n) during the length of time, the signal statistics analyzer 820 may select powers −13.5 dBFS and −8.5 dBFS as the subset. The subset is used to update the DPD coefficient cᵢ, such that a DPD coefficient cᵢ generated based on the subset (e.g., the two powers −13.5 dBFS and −8.5 dBFS) may be accurate for any input signals x(n) having powers less than −8.5 dBFS, as well as accurate for an input signal x(n) with a −8.5 dBFS and an input signal x(n) with a −13.5 dBFS. Alternatively, the signal statistics analyzer 820 may select the subset differently, such as selecting 2 of the highest powers and 1 of the lowest powers, selecting the highest power and the lowest power, selecting two transmission bandwidths, etc.

In the illustrated example of FIG. 8, the DPD iteration controller 825 is to instruct the coefficient update circuitry 810 when to update the DPD coefficient cᵢ based on how fast the profile of the input signal x(n) is changing and based on the fixed or maximum number of samples captured. The DPD iteration controller 825 generates two signals: an update signal and a retain signal. The DPD iteration controller 825 generates the retain signal when a maximum number of samples have been captured, but not all profiles or subset of profiles have been observed. For example, the DPD iteration controller 825 instructs the coefficient update circuitry 810 to hold off generating a new coefficient cᵢ, even when sufficient samples of the input signal x(n) are obtained. The DPD iteration controller 825 generates an update signal when a determination is made that the captured samples of the input signal x(n) includes samples for all the profiles in the profile list k or includes samples for the samples in the subset. For example, the DPD iteration controller 825 causes the coefficient update circuitry 810 to wait to update the DPD coefficient cᵢ until the capture engine 805 has observed (e.g., captured) the k profiles in the list or the subset of profiles.

In some examples, the DPD iteration controller 825 generates a trigger signal that causes the capture engine 805 to begin capturing a maximum number of samples or a fixed number of samples. In some examples, the DPD iteration controller 825 triggers the capture engine 805 to capture a maximum number of samples, greater than a fixed number of samples, when the profile change rate is greater than the threshold profile change rate α. In some examples, when the capture engine 805 is operating to capture the maximum number of samples, the DPD iteration controller 825 triggers the capture engine 805 to stop capturing samples when all profiles have been observed. For example, the DPD iteration controller 825 obtains the samples of the input signal x(n) from the capture engine 805 and determines whether the capture contains the list of profiles k. In some examples, when the DPD iteration controller 825 determines, in response to the maximum number of samples being captured, that not all the profiles have been observed and that the subset of profiles have not been observed, the DPD iteration controller 825 sends a retain signal to the coefficient update circuitry 810. In some examples, when the DPD iteration controller 825 determines, in response to the maximum number of samples being captured, that all the profiles have been observed or the subset have been observed, the DPD iteration controller 825 sends an update signal to the coefficient update circuitry 810.

The DPD iteration controller 825 modulates the time-span of data used for DPD estimation to include data from all profiles suggested by the signal statistics analyzer 820 before performing a DPD correction update. In some embodiments, the coefficient update circuitry 810 achieves the performance of a combined profile estimate C_{CPE}, generating a coefficient that will work for all profiles and not degrade the performance of the transmitter circuitry 200.

FIG. 9 is a flowchart of embodiment method 900, according to an embodiment of the present disclosure. Method 900 may be executed, instantiated, or performed by example programmable circuitry to implement the DPD estimator 310 of FIGS. 3 and 8.

Method 900 begins at block 902, at which the profile change rate (PCR) detector 815 determines a profile change rate (PCR) of the input signal x(n) during a time period. For example, the PCR detector 815 is to detect a change rate of the profile in the input signal x(n). In some examples, the PCR detector 815 computes the profile change rate by counting the number of profile changes between consecutive time period blocks (e.g., 200 ms blocks, 100 ms blocks, etc.) over a period of time (e.g., 20 seconds, 30 seconds, etc.).

At block 904, the PCR detector 815 determines whether the profile change rate is greater than a threshold profile change rate. For example, the PCR detector 815 compares the number of profile changes to a threshold number of profile changes indicative of changes faster than digital pre-distortion convergence time. The PCR detector 815 operates to determine whether the input signal x(n) is changing in profile frequently, where “frequently” is relative to how fast the DPD estimator 310 and DPD corrector circuitry 215 cause the output signal y(n) to converge with the input signal x(n).

If the PCR detector 815 determines that the profile change rate is not greater than the threshold profile change rate (e.g., block 904 returns a value NO), the DPD iteration controller 825 triggers a fixed capture of samples of the input signal x(n) and feedback signal L{y(n)} (block 906). For example, the PCR detector 815 sends a signal to the DPD iteration controller 825 indicating that the profile change rate is less than the time it takes the DPD corrector circuitry 215 to cause convergence between the output signal y(n) and the input signal x(n). The DPD iteration controller 825 does not interfere with the iterative update of the DPD coefficient cᵢ, and triggers the capture engine 805 to capture the fixed number of samples of the input signal x(n) and feedback signal L{y(n)}.

At block 908, the DPD iteration controller 825 sends a signal to trigger an update of DPD coefficient cᵢ based on the samples. For example, the DPD iteration controller 825 sends an “update” signal to the coefficient update circuitry 810 in response to the capture engine 805 capturing the fixed number of samples of the input signal x(n) and feedback signal L{y(n)}. The coefficient update circuitry 810 may update the coefficient cᵢ using the fixed number of samples captured.

If the PCR detector 815 determines that the profile change rate is greater than the threshold profile change rate (e.g., block 904 returns a value YES), the DPD iteration controller 825 triggers a capture of a maximum number samples of the input signal x(n) and feedback signal L{y(n)} (block 910). For example, the PCR detector 815 sends an “enable” signal to the DPD iteration controller 825 enabling the DPD iteration controller 825 to interfere with the iterative update of the DPD coefficient cᵢ until all or a subset of the k profiles are sampled.

At block 912, the DPD iteration controller 825 determines whether the maximum number of samples have been captured. For example, the capture engine 805 sends the captured samples of the input signal x(n) and the feedback signal L{y(n)} to the DPD iteration controller 825 so that the DPD iteration controller 825 can determine when to trigger an update of the DPD coefficient cᵢ and when to skip the coefficient cᵢ update (e.g., retain the DPD coefficient cᵢ).

While the DPD iteration controller 825 waits to receive the maximum number of samples (e.g., block 912 returns a value NO), the DPD iteration controller 825 determines whether the captured samples correspond to all k profiles (block 914). The signal statistics analyzer 820 identifies the k profiles observed at each consecutive time block during profile change rate detection. For example, the signal statistics analyzer 820 identifies and analyzes the statistics of the input signal x(n) during the 20 second, 30 second, etc., time period that the PCR detector 815 observes to identify the profile change rate. The signal statistics analyzer 820 outputs a list of k profiles identified to the DPD iteration controller 825. The DPD iteration controller 825 uses the list of k profiles to compare to the samples of x(n), captured by the capture engine 805. The DPD iteration controller 825 may perform a frequency analysis on the samples of the input signal x(n) to determine which profiles the capture engine 805 has sampled. In such an example, the DPD iteration controller 825 can monitor the profiles sampled by the capture engine 805 and determine whether the capture engine 805 has captured samples corresponding to the list of k profiles.

If the DPD iteration controller 825 determines that the captured samples correspond to all k profiles (e.g., block 914 returns a value YES), the DPD iteration controller 825 triggers an early exit from sample capturing (block 916). For example, the DPD iteration controller 825 may trigger the capture engine 805 to stop sampling the input signal x(n) and the feedback signal L{y(n)} because there is a sufficient representation of all the profiles in the samples captured.

Control turns to block 908, where the DPD iteration controller 825 sends a signal to trigger an update of the DPD coefficient cᵢ based on the samples. For example, the DPD iteration controller 825 instructs the coefficient update circuitry 810 to update the DPD coefficient cᵢ using the samples representing all k profiles. In such an example, the coefficient update circuitry 810 can generate a coefficient cᵢ that is similar to a combined profile estimate C_{CPE}.

If the DPD iteration controller 825 determines that the captured samples do not correspond to all k profiles (e.g., block 914 returns a value NO), control returns to block 912 where the DPD iteration controller 825 determines whether the maximum number of samples have been captured. For example, the DPD iteration controller 825 operates in a waiting and checking loop that is exited only when the captured samples correspond to all k profiles (e.g., block 914) or when the maximum number of samples is captured.

If the DPD iteration controller 825 determines that the maximum number of samples have been captured (e.g., block 912 returns a value YES), the DPD iteration controller 825 determines whether the captured samples of the input signal x(n) includes a subset of the k profiles (block 918). For example, when the maximum number of samples of the input signal x(n) have been captured, but do not correspond to all k profiles, the DPD iteration controller 825 determines whether the samples correspond to at least a subset of the k profiles. In some examples, the signal statistics analyzer 820 selects the subset of the k profiles. For example, the signal statistics analyzer 820 selects, based on the k profiles, which few profiles would sufficiently represent the k profiles. In some examples, the signal statistics analyzer 820 selects the two highest profiles in the list of k profiles. In some examples, the signal statistics analyzer 820 selects the highest profile and the lowest profile to be the subset. In some examples, the signal statistics analyzer 820 selects three or more profiles to be the subset. The signal statistics analyzer 820 provides the subset of k profiles to the DPD iteration controller 825 along with the list of k profiles.

If the DPD iteration controller 825 determines that the captured samples include the subset of profiles (e.g., block 918 returns a value YES), the DPD iteration controller 825 sends a signal to the coefficient update circuitry 810 to trigger an update of the DPD coefficient cᵢ based on the samples (block 920). For example, the DPD iteration controller 825 sends an “update” signal to the coefficient update circuitry 810. In some examples, the operations of blocks 920 and 908 are equivalent.

If the DPD iteration controller 825 determines that the captured samples do not include the subset of profiles (e.g., block 918 returns a value NO), the DPD iteration controller 825 sends a signal to the coefficient update circuitry 810 to trigger a retention of the DPD coefficient cᵢ (block 922). For example, the DPD iteration controller 825 interferes with iterative DPD coefficient estimation because updating the coefficient cᵢ when the profile of the input signal is changing faster than convergence may cause a degradation in the output signal y(n) unless the update is based on the subset of profiles observed in the input signal x(n).

The operations 900 may end when the DPD iteration controller 825 sends the signal to the coefficient update circuitry 810 triggering either a retention or an update of the DPD coefficient cᵢ. In some examples, the operations 900 may occur iteratively.

While an example manner of implementing the control circuitry DPD coefficient system 220 of FIG. 2 is illustrated in FIGS. 3, 4, 6, and 8, one or more of the elements, processes, or devices illustrated in FIGS. 3, 4, 6, and 8 may be combined, divided, re-arranged, omitted, eliminated, or implemented in any other way. Further, the example DPD coefficient estimation system 220 of FIG. 2, may be implemented by hardware alone or by hardware in combination with software and firmware. Thus, for example, the DPD coefficient estimation system 220 of FIGS. 3, 4, 6, and 8, could be implemented by programmable circuitry in combination with one or more machine-readable instructions (for example, firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example DPD coefficient estimation system 220 of FIGS. 3, 4, 6, and 8 may include one or more elements, processes, or devices in addition to, or instead of, those illustrated in FIGS. 3, 4, 6, and 8, or may include more than one of any or all of the illustrated elements, processes and devices.

Flowcharts representative of steps, which may be executed by programmable circuitry to at least one of implement or instantiate the DPD coefficient estimation system 220 of FIGS. 3, 4, 6, and 8 or representative of example operations which may be performed by programmable circuitry to at least one of implement or instantiate the DPD coefficient estimation system 220 of FIGS. 3, 4, 6, and 8, are shown in FIGS. 5, 7, and 9. If the steps are implemented as machine-readable instructions, the machine-readable instructions may be one or more executable programs or portion(s) of one or more executable programs for execution by programmable circuitry, such as a generic or custom processor. In some embodiments, one or more function(s) or portion(s) of functions to be performed by the programmable circuitry (for example, an FPGA).

As mentioned herein, the example operations of FIGS. 5, 7, and 9 may be implemented using executable instructions (for example, at least one of computer-readable or machine-readable instructions) stored on one or more non-transitory computer-readable or machine-readable media. As used herein, the terms non-transitory computer-readable medium, non-transitory computer-readable storage medium, non-transitory machine-readable medium, and non-transitory machine-readable storage medium are expressly defined to include any type of computer-readable storage device or storage disk and to exclude propagating signals and to exclude transmission media. Examples of such non-transitory computer-readable medium, non-transitory computer-readable storage medium, non-transitory machine-readable medium, or non-transitory machine-readable storage medium include flash memory, registers and/or flip-flops, read-only memory (ROM), etc.

Circuits described herein may be reconfigurable to include or replace components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated.

Example embodiments of the present disclosure are summarized here. Other embodiments can also be understood from the entirety of the specification and the claims filed herein.

Example 1. A method including: providing a first set of coefficients to a digital pre-distortion (DPD) corrector, the DPD corrector receiving a input signal having a first profile, the first set of coefficients being associated with the first profile; in response to detecting a change in a profile of the input signal from the first profile to a second profile, extracting, in response to an output signal converging to the input signal, a second set of coefficients corresponding to the second profile, the output signal being based on an output of the DPD corrector; and generating a third set of coefficients based on the first and second sets of coefficients, the third set being different from the first and second sets.

Example 2. The method of example 1, further including, in response to detecting a change in a profile of the input signal from the second profile to a third profile, providing the third set of coefficients to the DPD corrector for a first period of time.

Example 3. The method of one of examples 1 or 2, further including: after the first period of time and in response to the output signal converging to the input signal, extracting a fourth set of coefficients corresponding to the third profile; and updating the third set of coefficients based on the fourth set of coefficients.

Example 4. The method of one of examples 1 to 3, further including: extracting, in response to the output signal converging to the input signal, a correlation matrix associated with an amplifier outputting the output signal; and generating the third set of coefficients based on the correlation matrix.

Example 5. The method of one of examples 1 to 4, where the correlation matrix represents correlations between different nonlinear terms in a model used to correct nonlinearities of the amplifier.

Example 6. The method of one of examples 1 to 5, further including monitoring an error between the output signal and the input signal to determine when the output signal converges with the input signal.

Example 7. The method of one of examples 1 to 6, where convergence between the input signal and the output signal occurs after at least two iterations of pre-distorting the input signal by the DPD corrector.

Example 8. The method of one of examples 1 to 7, further including: detecting that the input signal changed from the first profile to a third profile over a period of time, the period of time greater than a time it takes for the output signal to converge with the input signal; providing the third set of coefficients to the DPD corrector for a first period of time corresponding to a first iteration of pre-distorting the input signal; generating a fourth set of coefficients in response to the output signal being adjusted based on the third set of coefficients; and providing the fourth set of coefficients to the DPD corrector for a second time period corresponding to a second iteration of pre-distorting the input signal.

Example 9. The method of one of examples 1 to 8, further including: waiting for the output signal to converge with the input signal; extracting, in response to the output signal converging to the input signal, a fifth set of coefficients corresponding to the third profile; and updating the third set of coefficients based on combining the third set of coefficients with the fifth set of coefficients.

Example 10. The method of one of examples 1 to 9, where the second set of coefficients is a projected coefficient vector, the method further including extracting a subset of matrices and a subset of projected coefficient vectors corresponding to a plurality of profiles.

Example 11. The method of one of examples 1 to 10, further including combining subsets of the matrices and subsets of the projected coefficient vectors for the plurality of profiles to generate the third set of coefficients.

Example 12. The method of one of examples 1 to 11, where the third set of coefficients is an updated third set of coefficients, the method further including: comparing a first time and temperature with a second time and temperature corresponding to the updated third set of coefficients; and removing the third set of coefficients from memory when the comparison returns a threshold difference between the first time and temperature and second time and temperature.

Example 13. The method of one of examples 1 to 12, where the first time corresponds a first timestamp of when the third set of coefficients was updated, the second time corresponds to a second timestamp of when the third set of coefficients was generated.

Example 14. The method of one of examples 1 to 13, where the first temperature corresponds to a temperature of a power amplifier providing the output signal at the first timestamp and the second temperature corresponds to the temperature of the power amplifier at the second timestamp.

Example 15. A method including: detecting a profile change in an input signal; selecting, in response to the profile change, a first coefficient corresponding to a first profile type of the input signal to pre-distort the input signal during a first iteration of digital pre-distortion correction; and generating a regularization vector based on at least one converged coefficient corresponding to a second profile type different than the first profile type of the first coefficient; and estimating a second coefficient for pre-distorting the input signal during a second iteration based on the regularization vector.

Example 16. The method of example 15, where the first profile type corresponds to a signal with a first power level, and where the second profile type corresponds to a signal with a second power level that is lower than the first power level.

Example 17. The method of one of examples 15 or 16, where the regularization vector is used to regularize the second coefficient with the converged coefficient generated for the second profile type.

Example 19. The method of one of examples 15 to 18, where the converged coefficient is a first converged coefficient, the method further including: obtaining a second converged coefficient corresponding to a third profile type; determining an average of the first converged coefficient and the second converged coefficient; and generating the regularization vector based on the average of the first converged coefficient and the second converged coefficient.

Example 20. The method of one of examples 15 to 19, further including generating the regularization vector based on converged coefficients corresponding to a plurality of profile types except the first profile type.

Example 21. The method of one of examples 15 to 20, where the converged coefficient is a first converged coefficient, the method further including: determining the input signal changed from a third profile type to a fourth profile type; in response to the profile change from the third profile type to the fourth profile type, waiting for an output signal to converge with the input signal; extracting, in response to the output signal converging to the input signal, a second converged coefficient corresponding to the converged output signal and the fourth profile type; generating a profile agnostic coefficient based on combining the first converged coefficient and the second converged coefficient; and generating the regularization vector based on the profile agnostic coefficient, where during the second iteration of digital pre-distortion, the profile agnostic coefficient is used to regularize the second coefficient.

Example 22. A method including: determining a number of profile changes of an input signal during a period of time; comparing the number of profile changes to a threshold number; identifying two or more profile types of the input signal during the period of time; triggering a capture of samples of the input signal; and determining whether to update a coefficient used for pre-distorting the input signal or retain a previous coefficient used for pre-distorting the input signal based on whether the capture of samples includes samples of the two or more profile types.

Example 23. The method of example 22, where the threshold number is indicative of a profile change rate that is faster than a transition time it takes for an output signal to converge with an input signal.

Example 24. The method of one of examples 22 or 23, where the coefficient is updated in iterations to pre-distort the input signal, the method further including initiating a capture of a predetermined number of samples of the input signal.

Example 25. The method of one of examples 22 to 24, further including: determining, in response to the predetermined number of samples being captured, that a subset of the two or more profile types were not sampled; and retaining the previous coefficient.

Example 26. The method of one of examples 22 to 25, further including: determining that the two or more profile types were sampled before the predetermined number of samples are captured; and exiting the capture of the predetermined number of samples.

Example 27. The method of one of examples 22 to 26, further including: determining that a subset of the two or more profile types were sampled before the predetermined number of samples are captured; and updating the coefficient.

Example 28. A device including: a digital pre-distortion (DPD) corrector having an output and an input; a digital-to-analog converter (DAC) having an input coupled to the output of the DPD corrector, and an output; a filter having an input coupled to the output of the DAC, and an output; an amplifier having an input coupled to the output of the filter; a DPD estimator having a first input coupled to the output of the amplifier, a second input coupled to the input of the DPD corrector, and an output; and a multiplexer having a first input coupled to the output of the DPD estimator, and an output coupled to the DPD corrector.

Example 29. The device of example 28, further including a coefficient estimator having an input coupled to the output of the DPD estimator, and an output coupled to a second input of the multiplexer.

Example 30. The device of one of examples 28 or 29, further including a profile change detector having an input coupled to the input of the DPD corrector, and an output coupled to a selection input of the multiplexer.

Example 31. The device of one of examples 28 to 30, where the profile change detector is configured to: in response to detecting the input of the DPD corrector changes from a first profile to a second profile, provide a first value to the selection input of the multiplexer for a first iteration of coefficient estimation, the first value to select the output of the coefficient estimator; and provide a second value to the selection input of the multiplexer for a second iteration of coefficient estimation, the second value to select the output of the DPD estimator.

Example 32. The device of one of examples 28 to 31, further including a coefficient estimator having a first input coupled to the input of the DPD corrector, a second input coupled to the output of the amplifier, and an output coupled to a second input of the multiplexer.

Example 33. The device of one of examples 28 to 32, where the coefficient estimator is configured to: extract a first coefficient corresponding to a first profile and a second coefficient corresponding to a second profile, the first coefficient used by the DPD corrector to converge the output of the amplifier to the input of the DPD corrector at a first time and the second coefficient used by the DPD corrector to converge the output of the amplifier to the input of the DPD corrector at a second time; generate a third coefficient based on combining the first coefficient with the second coefficient; and sending the third coefficient to the DPD corrector in response to detecting the input of the DPD corrector changing from the second profile to a third profile.

Example 34. The device of one of examples 28 to 33, where the coefficient estimator is configured to: in response to detecting the input of the DPD corrector changes from a first profile to a second profile, select a first coefficient corresponding to a third profile to provide to the DPD corrector for a first iteration of digital pre-distortion correction; and generate a regularization vector based on at least one converged coefficient corresponding to the first profile and the second profile, different than the third profile of the first coefficient; and estimating a second coefficient for pre-distorting the input of the DPD corrector during a second iteration based on the regularization vector.

Example 35. The device of one of examples 28 to 34, where the DPD estimator is configured to: determine that the input of the DPD corrector has a profile change rate greater than a threshold profile change rate based on analyzing a number of profile changes of the input of the DPD corrector over a period of time; identify two or more profiles of the input of the DPD corrector during the period of time; initiate a capture of samples of the input of the DPD corrector; and determine whether to update a coefficient used for pre-distorting the input of the DPD corrector or retain a previous coefficient used for pre-distorting the input of the DPD corrector based on whether the capture of samples includes samples of the two or more profiles.

Some embodiments may advantageously improve the efficiency of using a computing device by reducing memory storage requirements for digital pre-distortion estimation and simultaneously reducing a number of iterations needed to estimate DPD coefficients when the power and/or bandwidth of an input signal changes. Some embodiments may also reduce the memory storage requirements while simultaneously satisfying EVM and ACLR specifications, e.g., for 5G base stations by ensuring that the output signal of a transmitter does not significantly degrade when the profile of the input signal changes. Described systems, apparatus, articles of manufacture, and methods are accordingly directed to one or more improvement(s) in the operation of a machine such as a computer or at least one of other electronic device or mechanical device.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. A method comprising:
providing a first set of coefficients to a digital pre-distortion (DPD) corrector, the DPD corrector receiving a input signal having a first profile, the first set of coefficients being associated with the first profile;
in response to detecting a change in a profile of the input signal from the first profile to a second profile, extracting, in response to an output signal converging to the input signal, a second set of coefficients corresponding to the second profile, the output signal being based on an output of the DPD corrector; and
generating a third set of coefficients based on the first and second sets of coefficients, the third set being different from the first and second sets.

2. The method of claim 1, further comprising, in response to detecting a change in a profile of the input signal from the second profile to a third profile, providing the third set of coefficients to the DPD corrector for a first period of time.

3. The method of claim 2, further comprising:
after the first period of time and in response to the output signal converging to the input signal, extracting a fourth set of coefficients corresponding to the third profile; and
updating the third set of coefficients based on the fourth set of coefficients.

4. The method of claim 1, further comprising:
extracting, in response to the output signal converging to the input signal, a correlation matrix associated with an amplifier outputting the output signal; and
generating the third set of coefficients based on the correlation matrix.

5. The method of claim 4, wherein the correlation matrix represents correlations between different nonlinear terms in a model used to correct nonlinearities of the amplifier.

6. The method of claim 1, further comprising monitoring an error between the output signal and the input signal to determine when the output signal converges with the input signal.

7. The method of claim 1, wherein convergence between the input signal and the output signal occurs after at least two iterations of pre-distorting the input signal by the DPD corrector.

8. The method of claim 1, further comprising:
detecting that the input signal changed from the first profile to a third profile over a period of time, the period of time greater than a time it takes for the output signal to converge with the input signal;
providing the third set of coefficients to the DPD corrector for a first period of time corresponding to a first iteration of pre-distorting the input signal;
generating a fourth set of coefficients in response to the output signal being adjusted based on the third set of coefficients; and
providing the fourth set of coefficients to the DPD corrector for a second time period corresponding to a second iteration of pre-distorting the input signal.

9. The method of claim 8, further comprising:
waiting for the output signal to converge with the input signal;
extracting, in response to the output signal converging to the input signal, a fifth set of coefficients corresponding to the third profile; and
updating the third set of coefficients based on combining the third set of coefficients with the fifth set of coefficients.

10. The method of claim 1, wherein the second set of coefficients is a projected coefficient vector, the method further comprising extracting a subset of matrices and a subset of projected coefficient vectors corresponding to a plurality of profiles.

11. The method of claim 10, further comprising combining subsets of the matrices and subsets of the projected coefficient vectors for the plurality of profiles to generate the third set of coefficients.

12. The method of claim 1, wherein the third set of coefficients is an updated third set of coefficients, the method further comprising:
comparing a first time and temperature with a second time and temperature corresponding to the updated third set of coefficients; and
removing the third set of coefficients from memory when the comparison returns a threshold difference between the first time and temperature and second time and temperature.

13. The method of claim 12, wherein the first time corresponds a first timestamp of when the third set of coefficients was updated, the second time corresponds to a second timestamp of when the third set of coefficients was generated.

14. The method of claim 13, wherein the first temperature corresponds to a temperature of a power amplifier providing the output signal at the first timestamp and the second temperature corresponds to the temperature of the power amplifier at the second timestamp.

15. A method comprising:
detecting a profile change in an input signal;
selecting, in response to the profile change, a first coefficient corresponding to a first profile type of the input signal to pre-distort the input signal during a first iteration of digital pre-distortion correction; and
generating a regularization vector based on at least one converged coefficient corresponding to a second profile type different than the first profile type of the first coefficient; and
estimating a second coefficient for pre-distorting the input signal during a second iteration based on the regularization vector.

16. The method of claim 15, wherein the first profile type corresponds to a signal with a first power level, and wherein the second profile type corresponds to a signal with a second power level that is lower than the first power level.

17. The method of claim 16, wherein the regularization vector is used to regularize the second coefficient with the converged coefficient generated for the second profile type.

18. The method of claim 15, wherein the converged coefficient is a first converged coefficient, the method further comprising:
obtaining a second converged coefficient corresponding to a third profile type;
determining an average of the first converged coefficient and the second converged coefficient; and
generating the regularization vector based on the average of the first converged coefficient and the second converged coefficient.

19. The method of claim 15, further comprising generating the regularization vector based on converged coefficients corresponding to a plurality of profile types except the first profile type.

20. The method of claim 15, wherein the converged coefficient is a first converged coefficient, the method further comprising:
determining the input signal changed from a third profile type to a fourth profile type;
in response to the profile change from the third profile type to the fourth profile type, waiting for an output signal to converge with the input signal;
extracting, in response to the output signal converging to the input signal, a second converged coefficient corresponding to the converged output signal and the fourth profile type;
generating a profile agnostic coefficient based on combining the first converged coefficient and the second converged coefficient; and
generating the regularization vector based on the profile agnostic coefficient, wherein during the second iteration of digital pre-distortion, the profile agnostic coefficient is used to regularize the second coefficient.
